(19) United States
(12) Patent Application Publication
(10) Pub. No.: US 2015/0296454 A1
(43) Pub. Date: Oct. 15, 2015

(54) METHOD FOR LOW-POWER COMMUNICATIONS IN WIRELESS LOCAL AREA NETWORK AND APPARATUS FOR THE SAME

(71) Applicant: NEWRACOM, INC., Irvine, CA (US)

(72) Inventors: IL-GU LEE, Daejeon (KR); Chang Wahn YU, Daejeon (KR); Jeong-chul SHIN, Daejeon (KR); Kyeongpyo KIM, Daejeon (KR); Jong-Ee OH, Daejeon (KR)

(21) Appl. No.: 14/682,034

(22) Filed: Apr. 8, 2015

Related U.S. Application Data
(60) Provisional application No. 61/979,924, filed on Apr. 15, 2014.

(30) Foreign Application Priority Data
Oct. 31, 2014 (KR) 10-2014-0150292

(51) Int. Cl. H04W 52/02

(52) U.S. Cl. CPC H04W 52/0209; H04W 84/12

(57) ABSTRACT

Disclosed are methods and apparatuses for power saving in a Wireless Local Area Network (WLAN) system. A method for communication may comprise receiving a capability notification frame including first capability-related information from a second station; and configuring a power saving mode of the first station based on the first capability-related information. According to the present invention, power consumption efficiency of the communication system can be enhanced.

### CROSS-REFERENCE TO RELATED APPLICATIONS

This application claims priorities to U.S. Patent Application No. 61/979,924 filed on Apr. 15, 2014, and Korean Patent Application No. 10-2014-0150292 filed on Oct. 31, 2014, the entire contents of which are hereby incorporated by reference.

### BACKGROUND

1. Technical Field

The present invention relates to a low-power communication technology, and more particularly, to methods for low-power communications in wireless local area network (WLAN) and apparatuses for the same.

2. Related Art

With the development of information communication technologies, a variety of wireless communication technologies have been developed. Among these technologies, wireless local area network (WLAN) is a technology that Internet access is possible in a wireless way in homes, business or specific service providing areas, using portable terminal such as personal digital assistant (PDA), a laptop computer, a portable multimedia player (PMP), or the like, based on wireless frequency technologies.

WLAN technologies is created and standardized by the IEEE 802.11 Working Group under IEEE 802 Standard Committee. IEEE 802.11a provides a maximum PHY data rate of 54 Mbps using a 5 GHz unlicensed band. IEEE 802.11b provides a maximum PHY data rate of 11 Mbps by applying a direct sequence spread spectrum (DSSS) modulation at 2.4 GHz. IEEE 802.11g provides a maximum PHY data rate of 54 Mbps by applying orthogonal frequency division multiplexing (OFDM) at 2.4 GHz.

IEEE 802.11n provides a PHY data rate of 300 Mbps using two spatial streams and bandwidth of 40 MHz, and provides a PHY data rate of 600 Mbps using four spatial streams and bandwidth of 40 MHz.

As such WLAN technology becomes more prevalent and its applications become more diverse, there is increasing demand for new WLAN technology that can support a higher throughput than IEEE 802.11n. Very high throughput (VHT) WLAN technology, that is one of the IEEE 802.11 WLAN technologies, is proposed to support a data rate of 1 Gbps and higher. IEEE 802.11ac has been developed as a standard for providing VHT in the 5 GHz band, and IEEE 802.11ad has been developed as a standard for providing VHT in the 60 GHz band.

In addition to the above-described standards, various standards on WLAN technologies have been developed, and are being developed. As representative recent technologies, a WLAN technology according to IEEE 802.11af standard is a technology which has been developed for WLAN operation in TV white space bands, and a WLAN technology according to IEEE 802.11ah standard is a technology which has been developed for supporting a great number of stations operating with low power in sub 1 GHz band, and a WLAN technology according to IEEE 802.11ai standard is a technology which has been developed for supporting fast initial link setup (FILS) in WLAN systems. Also, IEEE 802.11ax standard is being developed for enhancing frequency efficiency of dense environments in which numerous access points and stations exist.

Advanced wireless communication technologies are being introduced to communication systems based on such the WLAN technologies in order to achieve high throughput and support high quality services. In this case, in order to maintain compatibility with conventional WLAN standards, circuits supporting new WLAN standards should be implemented in a station in addition to conventional WLAN circuits, and therefore a size of WLAN circuits becomes bigger. Also, although the amount of power consumption of communication systems increases rapidly according to increase of supported bandwidth, there has not been much advance in a battery technology for a station. Under these technological backgrounds, a WLAN chipset can be identified as the major power consuming part in a WLAN station.

On the other hand, in the WLAN system, a station may perform power saving methods by operating in a doze mode based on beacon frames received from an access point. In this case, the station may reduce power consumption through power gating or clock gating performed on whole circuits except a local timer. However, power saving methods for an awake mode have not been considered yet.

### SUMMARY

The present invention is directed to providing a power saving method for a wireless area network system.

The present invention is also directed to providing an apparatus for power saving in a wireless area network system.

In order to achieve the objectives of the present invention, a method for communication, performed in a first station, according to an example embodiment of the present invention, may comprise receiving a capability notification frame including first capability-related information from a second station; and configuring a power saving mode of the first station based on the first capability-related information.

Here, the first capability-related information include at least one of capability information of the second station and an indicator indicating notification of the capability information of the second station. Also, the capability information of the second station include at least one of information on a wireless local area network (WLAN) standard version, operation bandwidths, a center frequency, and operation bands supported by the second station. Also, the power saving mode of the first station is configured based on the capability information of the second station, when the first capability-related information include the capability information of the second station.

Here, the method may further comprise transmitting a capability request frame including second capability-related information to the second station, wherein the capability notification frame is a response to the capability request frame.

Also, the second capability-related information include at least one of capability information of the first station and an indicator indicating notification of the capability information of the first station.

Also, the capability information of the first station include at least one of information on a WLAN standard version, operation bandwidths, a center frequency, and operation bands supported by the first station.

Also, the power saving mode of the second station is configured based on the capability information of the first station, when the second capability-related information include the capability information of the first station.

Also, the power saving of the second station is configured based on capability of the second station, when the second capability-related information include the indicator indicating notification of the capability information of the first station.

Also, the power saving mode of the second station is configured based on the capability information of the first station and the capability of the second station, when the second capability-related information include the capability information of the first station.

Also, the capability notification frame is a clear-to-send (CTS) frame or a data frame, and the capability request frame is a request-to-send (RTS) frame or a power save (PS)-poll frame.

In order to achieve the objectives of the present invention, a method for communication, performed in a station, according to another example embodiment of the present invention, may comprise, when a data frame is received from an access point in an Orthogonal Frequency Division Multiple Access (OFDMA) manner, obtaining length information of an actual data field excluding a padding part in the received data frame; and operating in a power saving mode based on the length information of the actual data field from a reception end point of the actual data field.

Here, the length information of the actual data field is included in a signal A (SIGA) field or a signal B (SIGB) field of the data frame.

Also, the method may further comprise operating in an awake mode from the reception end point of the data frame.

In order to achieve the objectives of the present invention, a communication station, according to still another example embodiment of the present invention, may comprise a reception unit, including a plurality of units, configured to receive a frame; and a power management unit configured to control a power provided to each of the plurality of units according to each reception state of the frame.

Here, in a carrier sensing state, the power management unit configured to activate a carrier sensing unit among the plurality of units through control of a power provided to the carrier-sensing unit.

Also, when a short training field (STF) of the frame is received in the reception unit, the power management unit configured to activate a unit performing operations based on the STF among the plurality of units through control of a power provided to the unit performing operations based on the STF.

Also, when a long training field (LTF) of the frame is received in the reception unit, the power management unit configured to activate a unit performing operations based on the LTF among the plurality of units through control of a power provided to the unit performing operations based on the LTF.

Also, when a signal (SIG) field of the frame is received in the reception unit, the power management unit configured to activate a unit performing operations based on the SIG field among the plurality of units through control of a power provided to the unit performing operations based on the SIG field.

Also, when a data field of the frame is received in the reception unit, the power management unit configured to activate a unit performing operations based on the data field among the plurality of units through control of a power provided to the unit performing operations based on the data field.

According to the present invention, efficiency of power consumption in communication systems can be enhanced.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating an example embodiment of a wireless local area network (WLAN) system according to IEEE 802.11 standards;

FIG. 2 is a conceptual view illustrating an association process of a station in an infrastructure basic service set (BSS);

FIG. 3 is a flow chart illustrating a frame transmission procedure according to CSMA/CA scheme;

FIG. 4 is a flow chart illustrating a frame transmission/reception procedure of a station operating in power saving mode;

FIG. 5 is a block diagram illustrating an example embodiment of a station performing methods according to the present invention;

FIG. 6 is a block diagram illustrating an example embodiment of a receiving end of a station performing methods according to the present invention;

FIG. 7 is a block diagram illustrating an example embodiment of a power management unit of a station performing methods according to the present invention;

FIG. 8 is a conceptual diagram illustrating power saving methods applied to respective reception states for a legacy frame;

FIG. 9 is a conceptual diagram to explain power saving methods applied to respective reception states for a frame according to IEEE 802.11n/ac standards;

FIG. 10 is a state transition diagram to explain power saving methods applied to respective reception states for a frame according to IEEE 802.11n/ac standards;

FIG. 11 is a conceptual diagram to explain power saving methods applied to respective reception states for a frame according to IEEE 802.11ax standard;

FIG. 12 is a state transition diagram to explain power saving methods applied to respective reception states for a frame according to IEEE 802.11ax standard;

FIG. 13 is a flow chart illustrating a clock-based power saving method according to an example embodiment of the present invention;

FIG. 14 is a flow chart illustrating a CIN based power saving method according to an example embodiment of the present invention;

FIG. 15 is a conceptual diagram illustrating an example embodiment of a capability notification frame including capability-related information according to the present invention;

FIG. 16 is a conceptual diagram illustrating another example embodiment of a capability notification frame including capability-related information according to the present invention;

FIG. 17 is a conceptual diagram illustrating still another example embodiment of a capability notification frame including capability-related information according to the present invention.

FIG. 18 is a flow chart illustrating a CIN power saving method according to another example embodiment of the present invention;

FIG. 19 is a conceptual diagram to explain a CIN power saving method according to another example embodiment of the present invention.

FIG. 20 is a conceptual diagram to explain a dynamic clock based power saving method according to an example embodiment of the present invention;

FIG. 21 is a flow chart illustrating a power saving method for each station according to an example embodiment of the present invention;

FIG. 22 is a conceptual diagram illustrating an example embodiment of a data frame including power saving information;

FIG. 23 is a conceptual diagram illustrating another example embodiment of a data frame including power saving information;

FIG. 24 is a conceptual diagram illustrating still another example embodiment of a data frame including power saving information;

FIG. 25 is a conceptual diagram to explain a clock based power saving method using the data frame including power saving information;

FIG. 26 is a conceptual diagram to explain a station-specific power saving method according to another example embodiment of the present invention; and

FIG. 27 is a flow chart illustrating a power saving method based on WLAN standard version supported by an access point according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, and thus example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred example embodiments of the present invention will be described in detail with reference to the accompanying drawings. The same elements may have the same reference numerals to provide better understanding of the specification, and the details of elements identical will be omitted in order to avoid redundancy.

In this specification, a station (STA) represents a certain functional medium including a physical layer interface with respect to a medium access control (MAC) and a wireless medium according to provisions in IEEE 802.11 standards. The station STA is classified into a station serving as an access point (AP) and a station serving as a non-access point (non-AP). A station serving as an access point AP is referred to as an access point AP, and a station serving as a non-access point AP is referred to as a terminal.

The station STA includes a processor and a transceiver, and may further include a user interface and a display device. The processor represents a unit that is designed to generate a frame to be transmitted through a wireless network, or designed to process a frame received through a wireless network, and in order to control the station STA, the processor performs various functions. The transceiver represents a unit functionally connected to the processor, and designed to transmit and receive a frame for the station STA through a wireless network.

An access point AP may represent a centralized control device, a base station BS, a node-B, an e node-B, a base transceiver system (BTS), or a site control device, and may have some or the entire functions thereof.

A station may represent a wireless transmit/receive unit (WTRU), user equipment (UE), a user terminal (UT), an access terminal (AT), a mobile station (MS), a mobile terminal, a subscriber unit, a subscriber station (SS), a wireless device, or a mobile subscriber unit, and may have some or the entire functions thereof.

A station may perform communication using a desktop computer, a laptop computer, a tablet PC, a wireless phone, a mobile phone, a smart phone, an e-book reader, a Portable Multimedia Player (PMP), a portable game console, a navigation system, a digital camera, a Digital Multimedia Broadcasting (DMB) player, a digital audio recorder, a digital audio player, a digital picture recorder, a digital picture player, a digital video recorder, and a digital video player.

Example embodiments according to the present invention may be applied to WLAN systems according to IEEE 802.11 standards, and may also be applied to other communication systems. For example, example embodiments according to the present invention may be applied to mobile internet such as wireless personal area network (WPAN), wireless body area network (WBAN), world interoperability for microwave access (WiMax), or wireless broadband internet (WiBro), 2G mobile communication networks such as global system for mobile communication (GSM) and code division multiple access (CDMA), 3G mobile communication networks such as wideband code division multiple access (WCDMA) and cdma2000, 3.5G mobile communication networks such as high speed downlink packet access (HSDPA) and high speed uplink packet access (HSUPA), 4G mobile communication networks such as long term evolution (LTE) or LTE-Advanced, and 5G mobile communication networks.

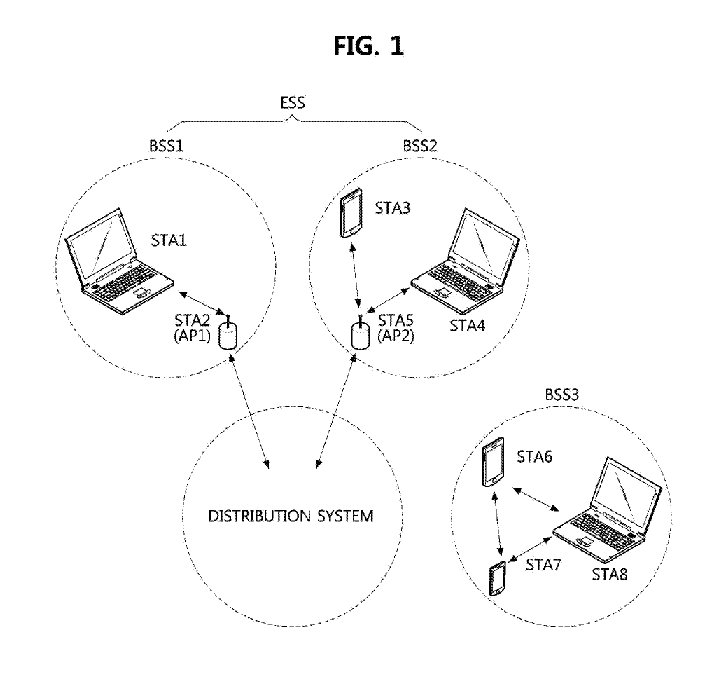

FIG. 1 is a conceptual diagram illustrating an example embodiment of a wireless local area network (WLAN) system according to IEEE 802.11 standards.

Referring to FIG. 1, an IEEE 802.11 WLAN system includes at least one basic service set (BSS). BSS represents a set of stations STA1, STA2 (AP1), STA3, STA4, STA5 (AP2), STA6, STA7, and STA8, rather than representing a designated region.

BSS may be classified into an infrastructure BSS and an independent BSS (IBSS). Here, BSS1 and BSS2 represent the infrastructure BSS, and BSS3 represents IBSS.

BSS1 may include a station STA1, an access point STA2 (AP1) providing a distribution service, and a distribution system DS connecting a plurality of access points STA2 (AP1) and STA5 (AP2). In BSS1, the access point STA2 (AP1) may manage the station STA1.

BSS2 may include stations STA3 and STA4, an access point STA5 (AP2) providing a distribution service, and the distribution system DS connecting the plurality of access points STA2 (AP1) and STA5 (AP2). In BSS2, the access point STA5 (AP2) may manage the stations STA3 and STA4.

BSS3 is an IBSS which is a BSS operating in an ad-hoc mode. In BSS3, there isn't an access point, a centralized management entity performing management functions at the center of the IBSS. That is, in BSS3, the stations STA6, STA7, and STA8 are managed in a distributed manner. All of the stations in BSS3 may be provided as a mobile station, and form a self-contained network since the stations are not allowed for an access to the DS.

The access points STA2 (AP1) and STA5 (AP2) provide the stations STA1, STA3, and STA4 connected thereto with an access to a DS through a wireless medium. In general, communications between the stations STA1, STA3, and STA4 in the BSS1 or the BSS2 are achieved through the access point STA2 (AP1) or STA5 (AP2). However, when a direct link is set, direct communications between the stations STA1, STA3, and STA4 may be possible.

A plurality of infrastructure BSSs may be connected to each other through the distribution system DS. The plurality of BSSs connected through the distribution system DS is referred to as an extended service set (ESS). The stations STA1, STA2 (AP1), STA3, STA4, and STA5 (AP2) included in an ESS may communicate with each other, and a station in the same ESS may move from one BSS to another BSS while seamlessly performing communications.

The distribution system DS is a mechanism for allowing one access point to communicate with another access point. The distribution system DS may allow an access point to transmit a frame provided for stations connected to a BSS that is managed by the access point, or to transmit a frame provided for a station that has moved to another BSS. In addition, the access point may transmit a frame with an external network, such as a wired network. The distribution system DS does not need to be a network, and may be implemented in various forms as long as it provides a predetermined distribution service set on IEEE 802.11 standards. For example, the distribution system may be a wireless network, such as a mesh network, or a physical structure connecting access points to each other.

In IEEE 802.11 standards, frames exchanged between stations are classified into management frames, control frames, and data frames. The management frame may mean a frame used for exchanging management information which are not forwarded to higher layer, and be transmitted after a backoff procedure is performed after a lapse of an interframe space (IFS) such as a distributed coordination function interframe space (DIFS) or point coordination function interframe space (PIFS).

Also, the control frame may mean a frame used for controlling access to medium. The control frame is transmitted after a backoff procedure is performed after a lapse of IFS when it is not a response frame to other frame, and is transmitted without a backoff procedure after a lapse of short interframe space (SIFS) when it is a response frame to other frame.

Also, the data frame may mean a frame used for transmitting data to be forwarded to higher layer, and be transmitted after a backoff procedure is performed after a lapse of IFS.

Each frame's type and subtype may be identified using a type field and a subtype field included in a control field of a frame. The below table 1 represents frames classified as management frames in IEEE 802.11ac standard.

TABLE 1

| Type value | | Subtype value | |
|---|---|---|---|
| b3 b2 | Type | b7 b6 b5 b4 | Subtype |
| 00 | Management | 0000 | Association request |
| 00 | Management | 0001 | Association response |
| 00 | Management | 0010 | Reassociation request |
| 00 | Management | 0011 | Reassociation response |
| 00 | Management | 0100 | Probe request |
| 00 | Management | 0101 | Probe response |
| 00 | Management | 0110 | Time advertisement |
| 00 | Management | 0111 | Reserved |
| 00 | Management | 1000 | Beacon |
| 00 | Management | 1001 | Announcement traffic |
| | | | indication message |
| | | | (ATIM) |
| 00 | Management | 1010 | Deassociation |
| 00 | Management | 1011 | Authentication |
| 00 | Management | 1100 | Deauthentication |
| 00 | Management | 1101 | Action |
| 00 | Management | 1110 | Action No ACK |
| 00 | Management | 1111 | Reserved |

The following table 2 represents frames classified as control frames in IEEE 802.11ac standard.

TABLE 2

| Type value | | Subtype value | |
|---|---|---|---|
| b3 b2 | Type | b7 b6 b5 b4 | Subtype |
| 01 | Control | 0000-0011 | Reserved |
| 01 | Control | 0100 | Beamforming report poll |
| 01 | Control | 0101 | Very high throughput null data |
| | | | packet announcement |
| | | | (VHT NDP announcement) |
| 01 | Control | 0111 | Control wrapper |
| 01 | Control | 1000 | Block ACK request |
| | | | (BlockAckReq) |
| 01 | Control | 1001 | Block ACK (BlockAck) |
| 01 | Control | 1010 | Power Save (PS)-poll |
| 01 | Control | 1011 | Request-to-Send (RTS) |
| 01 | Control | 1100 | Clear-to-Send (CTS) |
| 01 | Control | 1101 | ACK |
| 01 | Control | 1110 | Contention Free (CF)-end |
| 01 | Control | 1111 | CF-end + CF-Ack |

The following table 3 represents frames classified as data frames and reserved frames in IEEE 802.11ac standard.

TABLE 3

| Type | | | |
|---|---|---|---|
| value | | Subtype value | |
| b3 b2 | Type | b7 b6 b5 b4 | Subtype |
| 10 | Data | 0000 | Data |
| 10 | Data | 0001 | Data + CF-Ack |
| 10 | Data | 0010 | Data + CF-Poll |
| 10 | Data | 0011 | Data + CF-Ack + CF-Poll |
| 10 | Data | 0100 | Null |
| 10 | Data | 0101 | CF-Ack |
| 10 | Data | 0110 | CF-Poll |
| 10 | Data | 0111 | CF-Ack + CF-Poll |
| 10 | Data | 1000 | Quality of service (QoS) data |
| 10 | Data | 1001 | QoS data + CF-Ack |
| 10 | Data | 1010 | QoS data + CF-Poll |
| 10 | Data | 1011 | QoS data + CF-Ack + CF-Poll |
| 10 | Data | 1100 | QoS null |
| 10 | Data | 1101 | Reserved |
| 10 | Data | 1110 | QoS CF-Poll |
| 10 | Data | 1111 | QoS CF-Ack + CF-Poll |
| 11 | Reserved | 0000-1111 | Reserved |

In the infrastructure BSS, a station may be associated with an access point. When the station is associated to the access point, it may transmit and receive data.

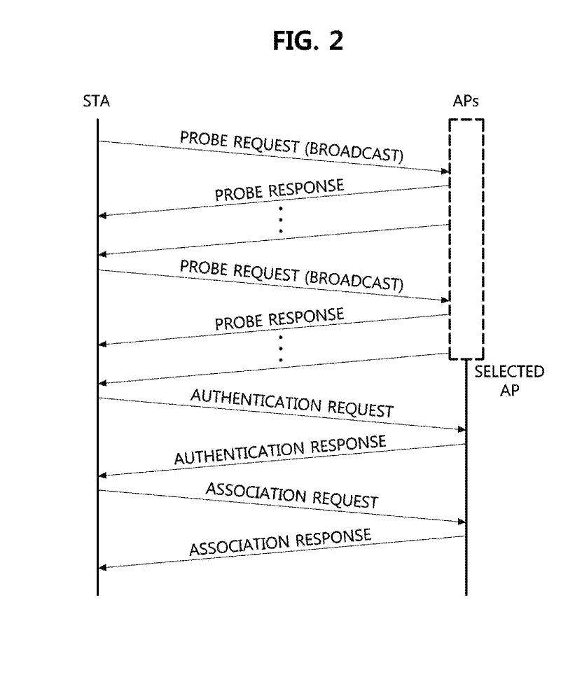

FIG. 2 is a conceptual view illustrating an association process of a station in an infrastructure BSS.

Referring to FIG. 2, an association process of a station STA in an infrastructure BSS is largely divided into a probe step of finding out an access point AP, an authentication step of authenticating the found access point, and an association step of performing association with the authenticated access point AP.

The station STA may search for nearby access points through a probe process. The probe process is classified into a passive scan method and an active scan method. The passive scan method is performed by overhearing a beacon transmitted by nearby access points APs. Meanwhile, the active scan method is performed by broadcasting probe request frames. An access point having received the probe request frame may transmit a probe response frame corresponding to the probe request frame to a corresponding station STA. The station STA may determine existences of the nearby access points APs by receiving the probe response frame.

Thereafter, the station STA performs authentication with respect to the found access point AP, thereby performing authentication with respect to the plurality of detected access points APs. An authentication algorithm according to the IEEE 802.11 standard is classified into an open system algorithm exchanging two authentication frames and a shared key algorithm exchanging four authentication frames. By exchanging an authentication request frame and an authentication response frame based on such an authentication algorithm, the station STA performs authentication with respect to access points APs.

After completion of the authentication process, the station may perform an association process with an access point. In this case, the station STA may select one access point among the plurality of authenticated access points APs, and perform an association with the selected access point AP. That is, the station STA may transmit an association request frame to the selected access point AP, and the access point AP having received the association request frame may transmit an association response frame corresponding to the association request frame to the station STA. By the process of exchanging the association request frame and the association response frame, the station STA performs the association with the access point AP.

The station STA associated to the access point AP may access a wireless channel based on distributed coordination function (DCF) and enhanced DCF (EDCF). That is, the station STA may access a wireless channel based on carrier sense multiple access—collision avoidance scheme (CSMA/CA) in order to avoid frame collisions in the wireless channel.

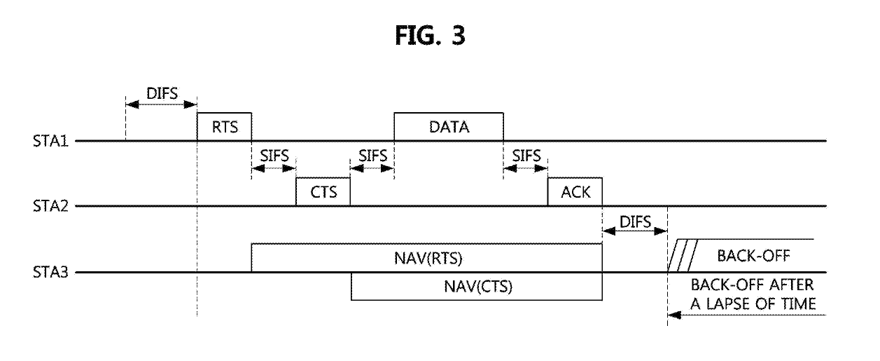

FIG. 3 is a flow chart illustrating a frame transmission procedure according to CSMA/CA scheme.

Referring to FIG. 3, a first station STA1 may mean a transmitting station to transmit data, and a second station STA2 may mean a receiving station to receive data transmitted from the first station STA1. Also, a third station STA3 may be located in a position where it can receive the frame transmitted from the first station STA1 and/or the frame transmitted from the second station STA2.

The first station STA1 may determine whether a wireless channel is being used (i.e. being occupied) through carrier sensing. The first station STA1 may determine whether the wireless channel is occupied or not based on energy existing in the wireless channel, or by using a network allocation vector (NAV) timer.

In case that it is determined that the wireless channel is not being occupied by other stations during a DCF interframe space (DIFS), the first station STA1 may transmit a request-to-send (RTS) frame to the second station STA2. On the receipt of the RTS frame, the second station STA2 may transmit a clear-to-send (CTS) frame to the first station STA1 in response to the RTS frame. In this case, the second station STA2 may transmit the CTS frame to the first station STA1 after a lapse of a short interframe space (SIFS) from a reception end point of the RTS frame.

Meanwhile, the third station STA3 which receives the RTS frame may set a NAV timer for a frame transmission duration for frames to be continuously followed later (e.g. SIFS+CTS frame+SIFS+data frame+SIF+acknowledgement (ACK) frame) by using duration information included in the received RTS frame. Alternatively, the third station which receives the CTS frame may set a NAV timer for the frame transmission duration for frames to be continuously followed later (e.g. SIFS+data frame+SIF+ACK frame) by using duration information included in the received CTS frame. Also, if the third station STA3 receives a new frame before the NAV timer is expired, it may update the NAV timer with duration information included in the new frame. The third station STA3 may not try to access the wireless channel before expiration of the NAV timer.

When the first station STA1 receives the CTS frame, it may transmit a data frame to the second station STA2 after a lapse of a SIFS from a reception end point of the CTS frame. The station STA2 having received the data frame successfully may transmit an ACK frame, a response to the data frame, to the first station STA1. In this case, the second station STA2 may transmit the ACK frame to the first station STA1 after a lapse of a SIFS from a reception end point of the data frame.

After the NAV timer is expired, the third station STA3 may determine whether the wireless channel is being used through carrier sensing. If it is determined that the wireless channel has not been used by other stations during a DIFS from the expiration of the NAV timer, the third station STA3 may try to access the wireless channel through a random backoff procedure.

On the other hand, in a WLAN system, a station may operate always in an awake mode, or operate in a power saving mode (i.e. doze mode) for reducing power consumption.

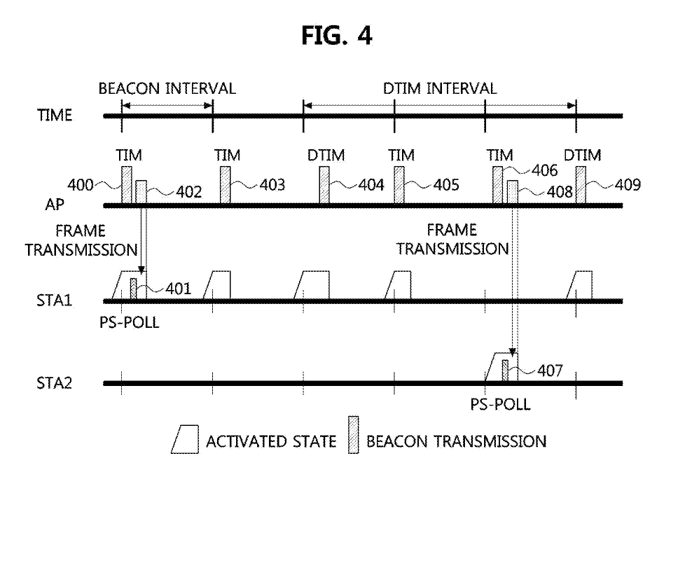

FIG. 4 is a flow chart illustrating a frame transmission/reception procedure of a station operating in power saving mode.

Referring to FIG. 4, the access point AP periodically broadcasts beacon frames 400, 403, 404, 405, 406, and 409, and in this case, may broadcast beacon frames 404 and 409 including a delivery traffic indication message (DTIM) at an interval of three beacons. The stations STA1 and STA2 in a power save mode (PSM) may be periodically awake and receive beacons 400, 403, 404, 405, 406, and 409, and check a traffic indication map (TIM) or DTIM included in the beacon frames, thereby determining whether data to be transmitted to the stations STA1 and STA2 is buffered in the access point. If buffered data exists in the access point, the stations STA1 and STA2 are kept awake to receive the data from the access point AP. If buffered data does not exist in the access point, the stations STA1 and STA2 return to a power save mode (PSM) that is, a doze mode.

That is, if a bit in a TIM corresponding to association ID (AID) of the stations STA1 and STA2 is set to 1, the stations STA1 and STA2 send the access point AP a Power Save (PS)-Poll frame (or trigger frame) indicating that the stations STA1 and STA2 are awake and ready for receiving data, and the access point AP having received the PS-Poll frame verifies that the stations STA1 and STA2 are ready for receiving data, and transmits data or acknowledgement (ACK) to the stations STA1 and STA2. When ACK is transmitted to the stations STA1 and STA2, the access point AP transmits data to the stations STA1 and STA2 at an adequate point of time. Meanwhile, if a bit in a TIM corresponding to AID of the stations STA1 and STA2 is set to 0, the stations STA1 and STA2 return to the PSM.

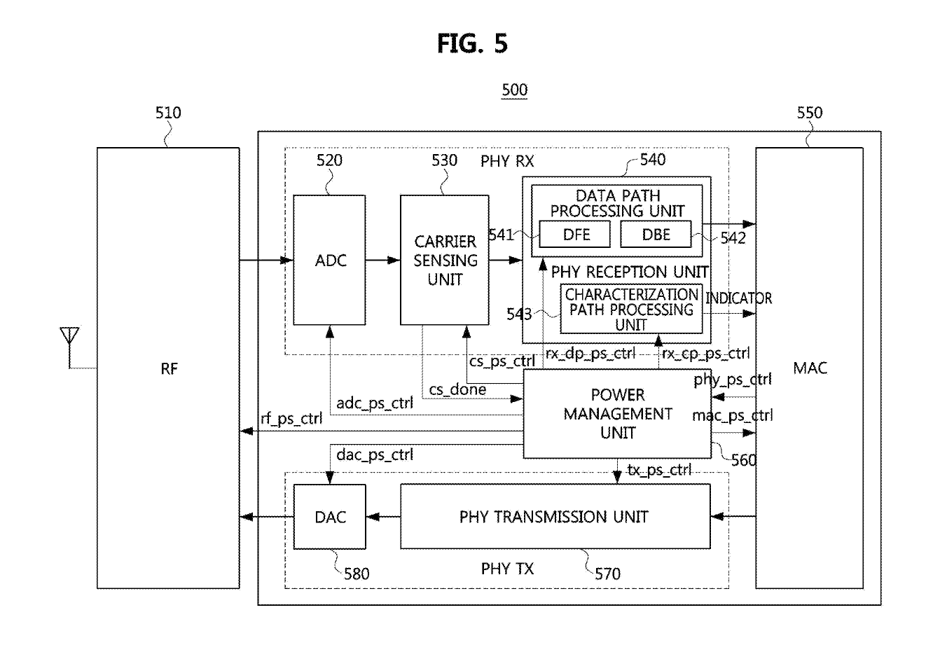

FIG. 5 is a block diagram illustrating an example embodiment of a station performing methods according to the present invention.

Referring to FIG. 5, a station 500 may comprise a radio frequency (RF) transceiving unit 510 and a digital modem. Also, the digital modem may include an analog-to-digital converter (ADC) 520, a carrier sensing unit 530, a physical layer (PHY) reception unit 540, a Medium Access Control (MAC) unit 550, a power management unit 560, a PHY transmission unit 570, and a digital-to-analog converter (DAC) 580. Here, units included in the digital modem may mean respective circuits performing corresponded functions.

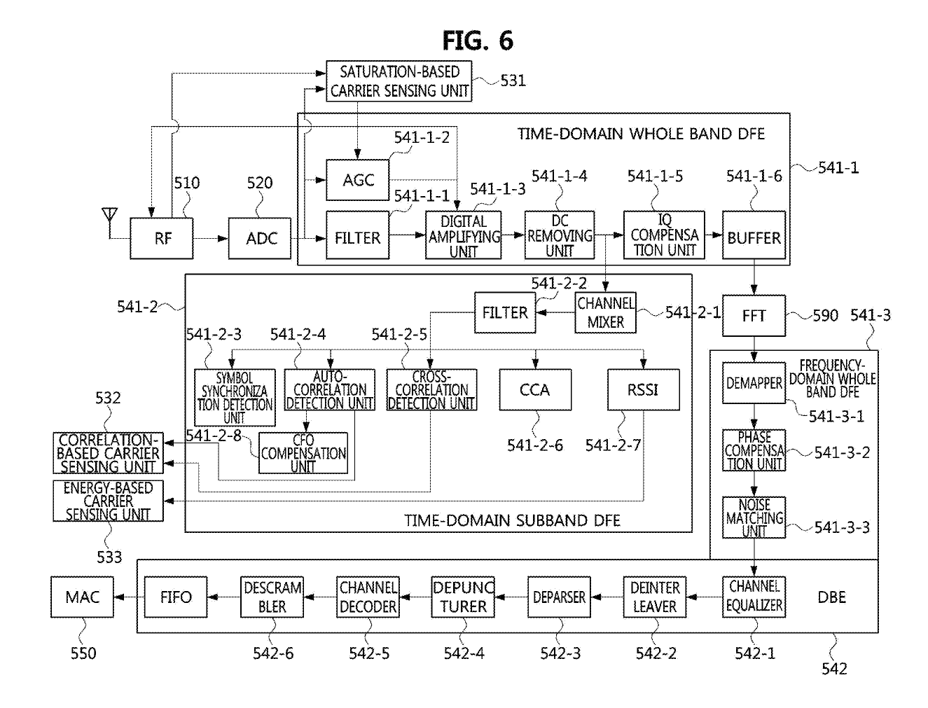

A physical layer reception (PHY RX) area may comprise the ADC 520, the carrier sensing unit 530, the PHY reception unit 540, and so on. The carrier sensing unit 530 may include at least one of a saturation-based carrier sensing unit 531, a correlation-based carrier sensing unit 532, and an energy-based carrier sensing unit 533. Here, the saturation-based carrier sensing unit 531, the correlation-based carrier sensing unit 532, and the energy-based carrier sensing unit 533 will be explained later by referring to FIG. 6.

The PHY reception unit 540 may include a data path processing unit comprising a digital front-end (DFE) 541 and a digital back-end (DBE) 542, and a characterization path processing unit 543. Also, the DFE 541 may comprise a time-domain whole band DFE 541-1, at least one time-domain sub-band DFE 541-2, and a frequency-domain whole band DFE 541-3. Here, the time-domain whole band DFE 541-1, the at least one time-domain sub-band DFE 541-2, and the frequency-domain whole band DFE 541-3 will be explained later by referring to FIG. 6.

Although the carrier sensing unit 530 is illustrated as a component separated from the DFE 541, it may be implement as included in the DFE 541 according to various implementations. Also, the physical layer transmission (PHY TX) area may comprise the PHY transmission unit 570, the DAC 580, and so on.

The power management unit 560 may control clocks (i.e. sampling rates) or powers provided to respective circuits included in the station 500. That is, the power management unit 560 may control clocks or powers for respective circuits by providing a xx_ps_ctrl signal, which is a power saving control signal, to each of the circuits. For example, the power management unit 560 may activate or deactivate the carrier sensing unit 530 by transmitting a cs_ps_ctrl signal to the carrier sensing unit 530.

Here, a rx_dp_ps_ctrl signal may be used for controlling power saving operations of the data path processing unit, and a rx_cp_ps_ctrl signal may be used for controlling power saving operations of the characterization path processing unit 543, and a phy_ps_ctrl signal may be used for controlling power saving operations of the PHY RX area and the PHY TX area.

Also, a mac_ps_ctrl signal may be used for controlling power saving operations of the MAC unit 550, and a tx_ps_ctrl signal may be used for controlling power saving operations of the PHY transmission unit 570, and a adc_ps_ctrl signal may be used for controlling power saving operations of the ADC 520. Also, a dac_ps_ctrl signal may be used for controlling power saving operations of the DAC 580, and a rf_ps_ctrl signal may be used for controlling power saving operations of the RF transceiving unit 510, and a cs_done signal may mean an indicator representing that a carrier is sensed.

The power management unit 560 may deactivate circuits in the PHY RX area when it is set to a transmission mode, and may deactivate circuits in the PHY TX area when it is set to a reception mode. The MAC unit 550 may control the power management unit 560 based on power saving methods according to MAC protocols.

When state-transitioned to a power saving mode (i.e. a doze mode) recognized by a beacon frame, the power management unit 560 may deactivate the RF transceiving unit 510, the circuits included in the PHY RX area, and the circuits included in the PHY TX area. When transmitting a frame in an awake mode, the power management unit 560 may activate the circuits included in the PHY TX area, and deactivate the circuits included in the PHY RX area.

On the contrary, when receiving a frame in an awake mode, the power management unit 560 may activate the circuits included in the PHY RX area, and deactivate the circuits included in the PHY TX area. However, since the circuits included in the PHY RX area do not know when the frame is to be received, they are required to always operate in a reception-ready state so that the circuits included in the PHY RX area consume a lot of energy. Thus, in order to resolve the above-described problem, a technique for lowering energy consumed in the awake mode is necessary.

Example embodiments of the present invention may be applied to legacy stations according to IEEE 802.11a/b/g standards, high throughput (HT) stations according to IEEE 802.11n standard, very high throughput (VHT) stations according to IEEE 802.11ac standard, and high-efficiency WLAN (HEW) stations according to IEEE 802.11ax standard.

FIG. 6 is a block diagram illustrating an example embodiment of a receiving end of a station performing methods according to the present invention.

Referring to FIG. 6, the receiving end of the station 500 may comprise the RF transceiving unit 510, the ADC 520, the saturation-based carrier sensing unit 531, the correlation-based carrier-sensing unit 532, the energy-based carrier sensing unit 533, the time-domain whole band DEF 541-1, the at least one time-domain sub-band DFE 541-2, a fast Fourier transform (FFT) performing unit 590, the frequency domain whole band DFE 541-3, the DBE 542, and the MAC 550. Here, respective units included in the receiving end of the station 500 may mean respective circuits performing corresponding functions.

Meanwhile, the station 500 in a communication system according to IEEE 802.11ac standard may perform communications using 20, 40, 80, and 160 MHz bandwidths. Also, the station 500 in a communication system according to IEEE 802.11ax standard may perform communications by using bandwidths wider than bandwidths used in the communications according to IEEE 802.11ac standard. A frame transmitted through each sub-band may include a preamble, and may be structured in unit of 20 MHz so that correlations, reception power, time/frequency synchronization characteristics, and so on of respective sub-bands can be analyzed. Therefore, the receiving end of the station 500 may include at least one time-domain sub-band DFE 541-2 for each sub-band in order to analyze characteristics of each sub-band.

The RF transceiving unit 510 may receive analog signals and transmit the received analog signals to the ADC 520. The ADC 520 may convert the received analog signals to digital signals, and transmit the converted digital signals to the time-domain whole band DFE 541-1. Among the DFEs, the time-domain whole band DFE 541-1 and the time-domain sub-band DFE 541-2 may be positioned before the FFT performing unit 590. Among the DFEs, the frequency-domain whole band DFE 541-3 may be positioned after the FFT performing unit 590.

The time-domain whole band DFE 541-1 may process whole band, and include a filter 541-1-1, an automatic gain control (AGC) 541-1-2, a digital amplifier 541-1-3, a direct current (DC) removing unit 541-1-4, an in-phase quadrature-phase (IQ) compensation unit 541-1-5, and a buffer 541-1-6, and so on.

The time-domain sub-band DFE 541-2 may comprise a channel mixer 541-2-1, a filter for analyzing signal characteristics 541-2-2, a symbol synchronization detection unit 541-2-3, an auto-correlation detection unit 541-2-4, a cross-correlation detection unit 541-2-5, a clear channel assessment (CCA) detection unit 541-2-6, a received signal strength indication (RSSI) detection unit 541-2-7, and a carrier frequency offset (CFO) compensation unit 541-2-8, and so on.

The frequency band whole band DFE 541-3 may comprise a demapper 541-3-1, a phase tracking unit 541-3-2, a noise matching unit 541-3-3, and so on.

The DBE 542 may comprise a channel equalizer 542-1, a deinterleaver 542-2, a deparser 542-3, a depuncturer 542-4, a channel decoder 542-5, a descrambler 542-6, and so on. That is, after channel compensation, the steps for deinterleaving, deparsing, depuncturing, decoding, and descrambling may be performed sequentially. Then, the DBE 540 may transmit the descrambled signals to the MAC unit 550.

In the following descriptions, a procedure for signal processing in the receiving end of the station 500 will be explained in detail.

First, the RF transceiving unit of the station 500 may receive signals. The received signals may be amplified with an initial gain value, and the amplified signals may be demodulated. The ADC 520 of the station 500 may convert the demodulated signals into digital signals, and transmit the converted signals to the filter 541-1-1, the AGC 541-1-2, the saturation-based carrier sensing unit 531, and so on.

The saturation-based carrier sensing unit 530 may determine that signals exist in a channel when signals are saturated in the RF transceiving unit 510 or the ADC 520. That is, the saturation-based carrier sensing unit 531 may determine that signals exist in a channel when power greater than a threshold value programed via a serial-to-parallel interface (SPI) is detected in an input end or an output end of the RF transceiving unit 510. Alternatively, the saturation-based carrier sensing unit 531 may be configured to count the number of samples of output signals of the ADC 520 having a value greater than a predefined threshold, and to determine that signals exist in a channel when the counted number of samples exceeds a predefined value.

After completion of the carrier sensing, the AGC 541-1-2 of the station 500 may perform AGC to adjust sizes of input signals to an operation region of the ADC 520 on the basis of input signal size of the ADC 520 or a RSSI obtained from the RF transceiving unit 510. The AGC 541-1-2 of the station 500 may perform AGC by controlling gains of a RF amplifying unit or the digital amplifier 541-1-3.

The filter 541-1-1 may be implemented as at least one analog filter or at least one digital filter, and the analog filter or the digital filter may filter out noise components of the gain-controlled signals. The DC removing unit 541-1-4 may remove time-varying DC components while performing gain control. The IQ compensation unit 541-1-5 of the station 500 may remove IQ gain or phase errors generated in the analog IQ path. The buffer 541-1-6 of the station 500 may compensate frequency errors of signals received from the IQ compensation unit 541-1-5.

On the other hand, the frequency errors may be estimated by using long preambles and short preambles. The demapper 541-3-1 of the station 500 may generate subcarrier indexes by classifying frequency-domain signals into data subcarriers and pilot subcarriers. The subcarrier indexes may be used in the phase compensation unit 541-3-2 and the channel equalizer 542-1.

The phase compensation unit 541-3-2 of the station 500 may include a circuit for compensating residual frequency error which remains after time-domain frequency error estimation with pilots, a circuit for estimating and compensating phase noise components by using pilots, a circuit for estimating and compensating timing offset, a circuit for compensating gain error, and so on. The residual frequency error estimation may be performed in frequency domain, and compensation of the residual frequency error may be performed in a time-domain FFT input buffer. Other phase error compensation, timing error compensation, and gain error compensation may be performed in frequency domain.

After compensation of phase error, the noise matching unit 541-3-3 of the station 500 may perform noise matching by using calculated noise values in time domain. After then, channel compensation may be performed.

Meanwhile, in the time-domain sub-band DFE 541-2, the channel mixer 541-2-1 of the station 500 may perform channel mixing for the whole band. The filter 541-2-2 of the station 500 may filter the mixed channel in 20 MHz channel units, and analyze characteristics of respective frames received through the 20 MHz channel units. Also, the filter 541-2-2 of the station 500 may transmit the analysis result of the frame characteristics to other circuits included in the station 500.

The symbol synchronization detection unit 541-2-3 may obtain symbol synchronization for each filtered sub-band. The auto-correlation detection unit 541-2-4 and the cross-correlation detection unit 541-2-5 may obtain signal correlations for each filtered sub-band. The CCA detection unit 541-2-6 may obtain CCA for each filtered sub-band. The RSSI detection unit 541-2-7 may obtain RSSI for each filtered sub-band. The CFO compensation unit 541-2-8 may perform CFO compensation based on the auto-correlation obtained from the auto-correlation detection unit 541-2-4.

The symbol synchronization information obtained through the symbol synchronization detection unit 541-2-3 may be transmitted to the input buffer of the FFT performing unit 590. The FFT performing unit 590 may identify a start point of a symbol by using the symbol synchronization information. Also, the FFT performing unit 590 may perform FFT so as to transform signals received from the buffer 541-1-6 into frequency-domain signals.

The correlation-based carrier sensing unit 532 may perform carrier sensing based on auto-correlation obtained through the auto-correlation detection unit 541-2-4 and cross-correlation obtained through the cross-correlation detection unit 541-2-5. That is, the correlation-based carrier sensing unit 532 may calculate auto-correlation or cross-correlation by using periodicity of preambles, and determine that signals exist in a channel when the calculated correlation is greater than a predetermined threshold value.

The energy-based carrier sensing unit 533 may perform carrier sensing based on RSSI obtained through the RSSI detection unit 541-2-7. That is, the energy-based carrier sensing unit 533 may determine that signals exist in a channel when energy greater than a threshold value configured in a programmable register is detected.

Meanwhile, in the DBE 542, the steps for deinterleaving, deparsing, depuncturing, channel decoding, and descrambling may be performed as opposite to the steps performed in the transmitting end. Also, channel estimation may be performed in the channel equalizer 542-1. The deinterleaver 542-2 may perform deinterleaving on signals received from the channel equalizer 542-1. The deparser 542-3 may perform deparsing on signals received from the deinterleaver 542-2. The depuncturer 542-4 may perform depuncturing on signals received from the deparser 542-3.

The channel decoder 542-5 may perform decoding on signals received from the depuncturer 542-4. The channel decoder 542-5 may be a Viterbi decoder, a low density parity check (LDPC) decoder, and so on. Information on the channel decoder 542-5 which is currently operating may be transferred using a SIG field included in a frame. The descrambler 542-6 may perform descrambling on signal received from the channel decoder 542-5. The signals which have been processed through the above-described procedure may be transmitted to the MAC unit 550 in a first-in first-out (FIFO) manner.

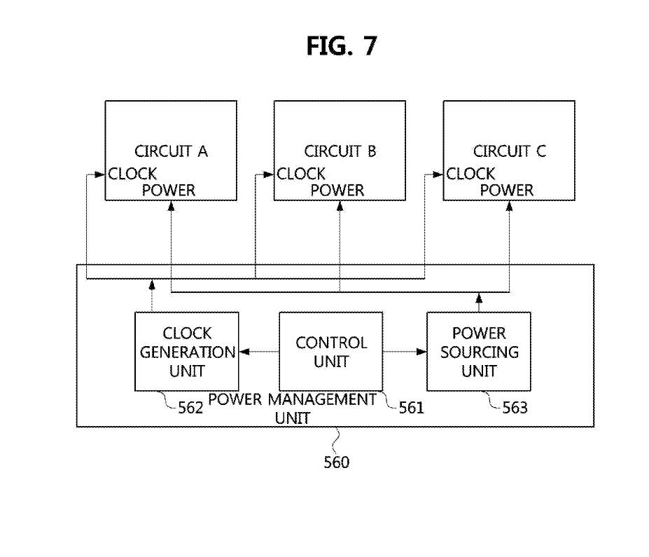

FIG. 7 is a block diagram illustrating an example embodiment of a power management unit of a station performing methods according to the present invention.

Referring to FIG. 7, the power management unit 560 of the station 500 may comprise a control unit 561, a clock generation unit 562, and a power sourcing unit 563. The control unit 561 may enhance power consumption efficiency by activating a part of circuits and deactivating the other part of circuits according to a frame reception state. The control unit 561 may activate or deactivate circuits through clock gating or power gating. The amount of power consumption may be represented as below equations.

P=Pₛ+P_{d} [Equation 1]

P_{d}=C*f*V² [Equation 2]

Here, P means the amount of power consumption, and Pₛ means the amount of static power consumption, and P_{d} means the amount of dynamic power consumption. The static power consumption is determined according to chip manufacturing process and chip layouts, and generated in a leakage current form even when the chip is not being driven.

Also, C means the size of gates (i.e. the size of a circuit being driven), and f means a clock driving the circuit, and V means a voltage applied to the circuit. The dynamic power consumption is proportional to C, f, and V². Here, since it is very difficult to decrease V and it is dependent on manufacturing process applied to the chip, it is more efficient to adjust C and F for reducing total power consumption (P). That is, since all of circuits included in the station 500 are not needed to be activated or operated at a high clock frequency, dynamic power consumption may be minimized by optimizing C and f according to given operation environments.

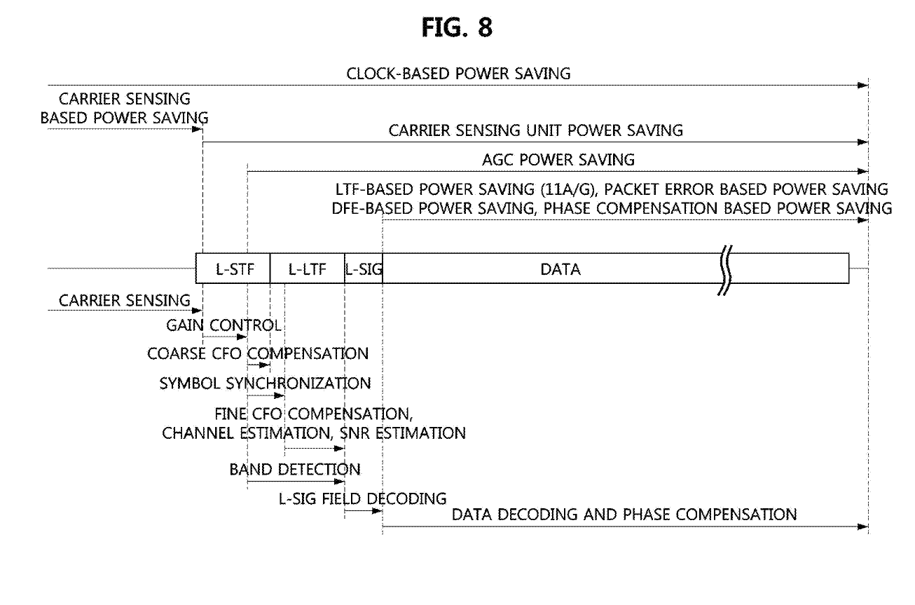

In the following descriptions, referring to FIGS. 8 to 12, example embodiments of power saving methods in awake mode applied to respective reception states of a frame in a WLAN system will be explained. The example embodiments of the power saving methods may be executed in an independent manner or in a combination manner where two or more embodiments are combined. Also, a part or all of technical elements in each example embodiment may be executed as combined with a part or all of technical elements in other example embodiments.

FIG. 8 is a conceptual diagram illustrating power saving methods applied to respective reception states for a legacy frame.

Referring to FIG. 8, a legacy frame may comprise a legacy short training field (L-STF), a legacy long training field (L-LTF), a legacy signal (L-SIG) field, and a data field. Here, the legacy frame may mean a frame according to IEEE 802.11a/b/g standards.

In a clock determining state, the power management unit 560 of the station 500 may determine a clock frequency based on a WLAN standard version, an operation bandwidth, a center frequency, and operation bands supported by an access point with which the station 500 is associated. That is, the power management unit 560 of the station 500 may determine its operation clock frequency to be twice (or, more than two times) of the operation bandwidth on which the access point operates. Then, the power management unit 560 may configure circuits included in the station 500 with the determined clock frequency.

After configuring the clock frequency, carrier sensing may be performed. In a carrier sensing state, the power management unit 560 may activate the carrier sensing unit 530 and related circuits which are needed for the carrier sensing (i.e. at least one of the saturation-based carrier sensing unit 531, the correlation-based carrier sensing unit 532, and the energy-based carrier sensing unit 533), and deactivate other circuits except circuits for performing carrier sensing.

Specifically, the correlation-based carrier sensing unit 532, one of main circuits corresponding to the carrier sensing state, may be activated, and in order to support normal operation of the correlation-based carrier sensing unit 532, the power management unit 560 may activate relevant units along a path from the RF transceiving unit 510 to the correlation-based carrier sensing unit 532, such as the RF transceiving unit 510, the ADC 520, the filter 541-1-1, the digital amplifier 541-1-3, the DC removing unit 541-1-4, the channel mixer 541-2-1, the filter 541-2-2, the auto-correlation detection unit 541-2-4, the correlation-based carrier sensing unit 532, and so on.

Also, for power saving, the power management unit 560 may deactivate at least one unit which does not belong to the above path. Hereinafter, activating units corresponding to a specific state may also include activating relevant units positioned along a path to the units corresponding to the specific state (i.e. units related to operations of the units corresponding to the specific state). Also, deactivating units which are not corresponding to a specific state may mean deactivating at least one unit which is not positioned along a path to the unit corresponding to the specific state (i.e. units which are not related to operations of the units corresponding to the specific state).

The carrier sensing unit 530 of the station 500 may determine whether a signal exists in a channel through carrier sensing. That is, the carrier sensing unit 530 may determine whether a signal exists in a channel by detecting a L-STF of a frame. When the carrier sensing unit 530 does not detect a signal in the channel (i.e. an idle state), the carrier sensing unit 530 may continuously perform the carrier sensing.

When it is determined that a signal exists in the channel, an automatic gain control (AGC) on the detected signal may be performed. In a gain control state, the power management unit 560 of the station 500 may activate the AGC 541-1-2, a circuit responsible for performing AGC, among circuits included in the station 500, and deactivate circuits which are not related to the AGC operation. The AGC 541-1-2 may measure the size of input signals based on the L-STF of the received frame, and adjust a gain for the input signals to an operation range of the ADC 520 based on the measurement result.

After completion of the AGC, parameters related to the AGC may be stored in registers, and the power management unit 560 may deactivate the AGC 541-1-2. On the other hand, if the AGC operation fails (i.e. the AGC operation has not been completed during a predetermined time period), the reception state of the station 500 may be transitioned again to the carrier sensing state. That is, the power management unit 560 may deactivate the AGC 541-1-2 and activate the carrier sensing unit 530 again.

After completion of the AGC, a coarse CFO compensation on the gain-controlled signal may be performed. In a coarse CFO compensation state, the power management unit 560 may activate the CFO compensation unit 541-2-8, a circuit for performing the coarse CFO compensation, among the circuits included in the station 500, and deactivate other circuits which are not related to the coarse CFO compensation operation. The CFO compensation unit 541-2-8 may coarsely compensate a carrier frequency offset based on the L-STF of the frame.

After completion of the coarse CFO compensation, the power management unit 560 may deactivate the CFO compensation unit 541-2-8. On the other hand, if the coarse CFO compensation fails (i.e. the coarse CFO compensation has not been completed during a predetermined time period), the reception state of the station 500 may be state-transitioned again to the carrier sensing state. That is, the power management unit 560 may deactivate the CFO compensation unit 541-2-8 and activate the carrier sensing unit 530 again.

After completion of the coarse CFO compensation, symbol synchronization detection may be performed on the compensated signal. In a symbol synchronization detection state, the power management unit 560 may activate the symbol synchronization detection unit 541-2-3, a circuit for performing the symbol synchronization detection, among the circuits included in the station 500, and deactivate circuits which are not related to the symbol synchronization detection. The symbol synchronization detection unit 541-2-3 may estimate an end point of the L-STF in the frame, and estimate a guard interval, a start point of a L-LTF, based on the end point of the L-STF.

After completion of the symbol synchronization detection, the power management unit 560 may deactivate the symbol synchronization detection unit 541-2-3. On the other hand, if the symbol synchronization detection fails (i.e. the symbol synchronization detection has not been completed during a predetermined time period), the reception state of the station 560 may be transitioned again to the carrier sensing state. That is, the power management unit 560 may deactivate the symbol synchronization unit 541-2-3 and activate the carrier sensing unit 530.

After completion of the symbol synchronization detection, a fine CFO compensation may be performed. In a fine CFO compensation state, the power management unit 560 may activate the CFO compensation unit 541-2-8, a circuit for performing the fine CFO compensation, among the circuits included in the station 500, and deactivate circuits which are not related to the fine CFO compensation. The CFO compensation unit 541-2-8 may finely compensate a carrier frequency offset based on the L-LTF of the frame.

After completion of the fine CFO compensation, the power management unit 560 may deactivate the CFO compensation unit 541-2-8. On the other hand, if the fine CFO compensation fails (i.e. the fine CFO compensation has not been completed during a predetermined time period), the reception state of the station 560 may be transitioned again to the carrier sensing state. That is, the power management unit 560 may deactivate the CFO compensation unit 541-2-8 and activate the carrier sensing unit 530.

After completion of the fine CFO compensation, channel estimation may be performed. In a channel estimation state, the power management unit 560 may activate the channel equalizer 542-1, a circuit for performing the channel estimation, among the circuits included in the station 500, and deactivate circuits which are not related to the channel estimation. The channel equalizer 542-1 may estimate a channel state based on the L-LTF of the frame, and estimate a signal to noise ratio (SNR) based on the estimated channel state. The estimated channel state may be used for decoding a L-SIG field included in the frame.

After completion of the channel estimation, the L-SIG field may be decoded. In a L-SIG field decoding state, the power management unit 560 may activate the channel decoder 542-5, a circuit for performing the channel decoding, among the circuits included in the station 500, and deactivate circuits which are not related to the channel decoding. The channel decoder 542-5 may compare a link quality demanded according to a frame length and rate information obtained from the L-SIG field with the SNR estimated based on the channel state.

Based on the result of the comparison between the demanded link quality and the SNR, if decoding is determined to be impossible (i.e. the demanded link quality is above the SNR), the power management unit 560 may deactivate all circuits included in the receiving end during a frame transmission time estimated according to the frame length and rate information obtained from the L-SIG field (i.e. a RX power saving state). After completion of the frame transmission time, the power management unit 560 may re-activate the carrier sensing unit 530 (i.e. the carrier sensing state). On the contrary, if decoding is determined to be possible (i.e. the demanded link quality is below the SNR), the channel decoder 542-5 may decode the L-SIG field.

After decoding the L-SIG field, a phase error compensation may be performed. In a phase error compensation state, the power management unit 560 may activate the phase error compensation unit 541-3-2, a circuit for performing the phase error compensation, among the circuits included in the station 500, and deactivate circuits which are not related to the phase error compensation. The phase error compensation unit 541-3-2 may estimate a phase error and compensate the estimated phase error. Once a loop filer for the phase error compensation is stabilized, the power management unit 560 may deactivate the phase error compensation unit 541-3-2.

The deactivation duration of the phase error compensation unit 541-3-2 may vary according to the length of the frame. For example, if the frame has a length shorter than a predefined length, the power management unit 560 may deactivate the phase error compensation unit 541-3-2 until a reception end point of the frame. On the contrary, if the frame has a length longer than a predefined length, the power management unit 560 may control the phase error compensation unit 541-3-2 to estimate and compensate phase errors periodically.

After decoding the L-SIG field, a data field may be decoded. In a data field decoding state, the MAC unit 550 may decode the data field. After decoding the data field, the power management unit 560 may deactivate the carrier sensing unit 530.

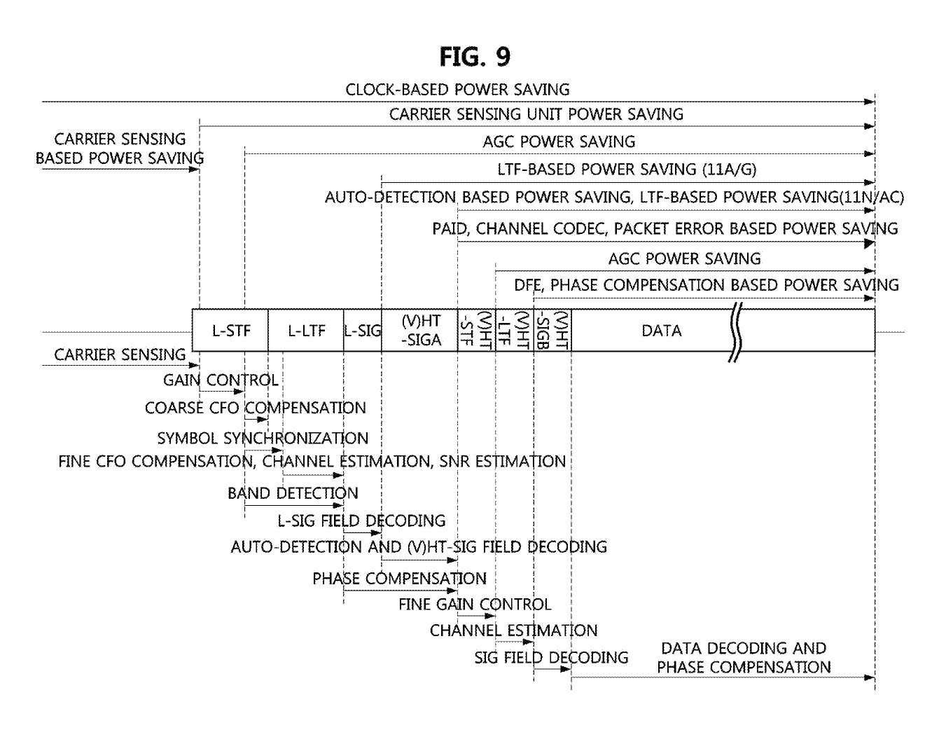

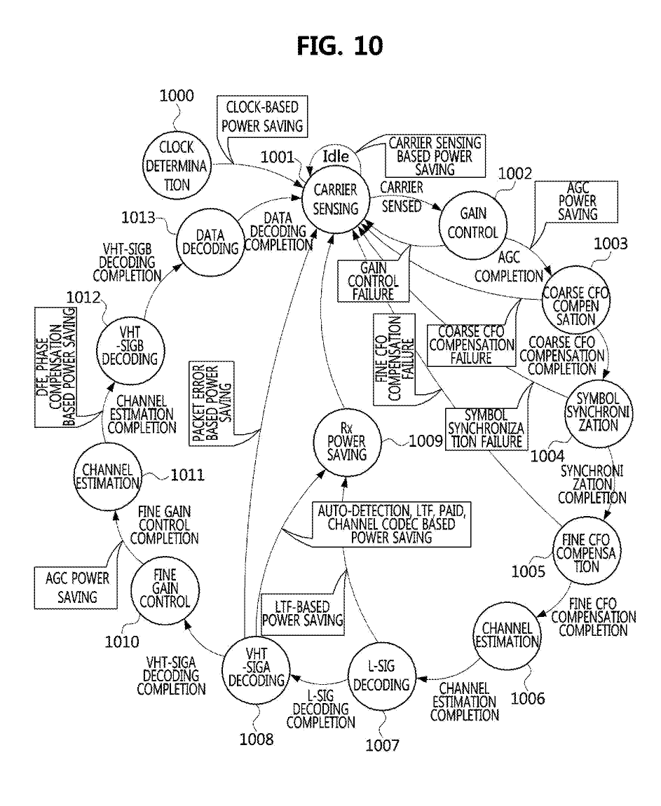

FIG. 9 is a conceptual diagram to explain power saving methods applied to respective reception states for a frame according to IEEE 802.11n/ac standards, and FIG. 10 is a state transition diagram to explain power saving methods applied to respective reception states for a frame according to IEEE 802.11n/ac standards.

Referring to FIG. 9 and FIG. 10, a frame according to IEEE 802.11n standard may comprise a L-STF, a L-LFT, a L-SIG field, a high throughput signal A (HT-SIGA) field, a high throughput STF (HT-STF), a high throughput LTF (HT-LTF), a HT-SIGB field, and a data field. A frame according to IEEE 802.11ac standard may comprise a L-STF, a L-LTF, a L-SIG field, a very high throughput signal A (VHT-SIGA) field, a very high throughput STF (VHT-STF), a very high throughput LTF (VHT-LTF), a VHT-SIGB field, and a data field.

Operations of the power management unit 560 and circuits controlled by the power management unit 560 in a clock determination state 1000, a carrier sensing state 1001, a gain control state 1002, a coarse CFO compensation state 1003, a symbol synchronization detection state 1004, a fine CFO compensation state 1005, a channel estimation state 1006, and a L-SIG field decoding state 1007 may be identical to those of corresponding states explained referring to FIG. 8.

After decoding the L-SIG field, the HT-SIGA field or the VHT-SIGA field may be decoded. In a HT-SIGA field (or, VHT-SIGA field) decoding state 1008, the channel decoder 542-5 of the station 500 may estimate a demanded link quality based on modulation and coding scheme (MCS) information, frame length information, and transmission mode information obtained from the HT-SIGA field (or, the VHT-SIGA field).

The channel decoder 542-5 may compare the demanded link quality (i.e. a link quality required for successful frame reception according to the length of frame, bandwidth, supported standard version, transmission mode, and so on) with a SNR estimated based on channel states. If the demanded link quality is equal to or more than the SNR, the power management unit 560 may deactivate all circuits included in the receiving end during an estimated frame transmission time (i.e. a RX power saving state 1009). After completion of the frame transmission time, the power management unit 560 may activate the carrier sensing unit 530 (i.e. a carrier sensing state 1001).

Also, when a CRC error is detected in decoding the HT-SIGA field (or, the VHT-SIGA field), the reception state of the station 500 may be transitioned from the HT-SIGA (or, VHT-SIGA) field decoding state 1008 to the carrier sensing state 1001. That is, the power management unit 560 may deactivate the channel decoder 542-5 and activate the carrier sensing unit 530. On the contrary, if the demanded link quality is below the SNR, the channel decoder 524-5 may decode the HT-SIGA field (or, the VHT-SIGA field) and the data field.

After completion of decoding the HT-SIGA field (or, the VHT-SIGA field), a fine gain control may be performed. In a fine gain control state 1010, the power management unit 560 may activate the AGC 541-1-2, a circuit for performing the fine gain control, among circuits included in the station 500, and deactivate circuits which are not related to the fine gain control. The AGC 541-1-2 of the station 500 may finely control a gain based on the HT-STF (or, the VHT-STF). Since the gain of beamforming signals may vary largely, the AGC 541-1-2 may compensate the gain variation of beamforming signals. After completion of the fine gain control, the power management unit 560 may deactivate the AGC 541-1-2.

After the fine gain control, channel estimation may be performed. In the channel estimation state 1011, the power management unit 560 may activate the channel equalizer 542-1, the circuit for performing the channel estimation, among circuits included in the station 500, and deactivate circuits which are not related to the channel estimation. The channel equalizer 542-1 may estimate channel state based on the HT-LTF (or, the VHT-LTF). After completion of the channel estimation, the power management unit 560 may deactivate the channel equalizer 542-1. Also, after receiving the HT-LTF (or, the VHT-LTF), the power management unit 560 may deactivate all of circuits necessary for extracting signal characteristics for respective sub-bands.

After the channel estimation, the HT-SIGB field (or, the VHT-SIGB field) may be decoded. In the HT-SIGB field (or, the VHT-SIGB field) decoding state 1012, the power management unit 560 may activate the channel decoder 542-5, the circuit for decoding, among circuits included in the station 500, and deactivate circuits which are not related to the channel decoding. The channel decoder 542-5 may decode the HT-SIGB field (or, the V HT-SIGB field). After decoding the HT-SIGB field (or, the VHT-SIGB field), the power management unit 560 may deactivate the channel decoder 542-5.

After decoding the HT-SIGB field (or, the VHT-SIGB field), a phase error compensation may be performed. In the phase error compensation state, the power management unit 560 may activate the phase error compensation unit 541-3-2, the circuit for performing the phase error compensation, among circuits included in the station 500, and deactivate circuits which are not related to the phase error compensation. The phase error compensation unit 541-3-2 may estimate a phase error and compensate the estimated phase error. Once a loop filer for the phase error compensation is stabilized, the power management unit 560 may deactivate the phase error compensation unit 541-3-2.

The deactivation duration of the phase error compensation unit 541-3-2 may vary according to the length of the frame. For example, if the frame has a length shorter than a predefined length, the power management unit 560 may deactivate the phase error compensation unit 541-3-2 until a reception end point of the frame. On the contrary, if the frame has a length longer than a predefined length, the power management unit 560 may control the phase error compensation unit 541-3-2 to estimate and compensate phase errors periodically.

After decoding the HT-SIGB field (or, the VHT-SIGB field), the data field may be decoded. In the data field decoding state 1013, the MAC unit 550 may decode the data field. After decoding the data field, the power management unit 560 may activate the carrier sensing unit 530.

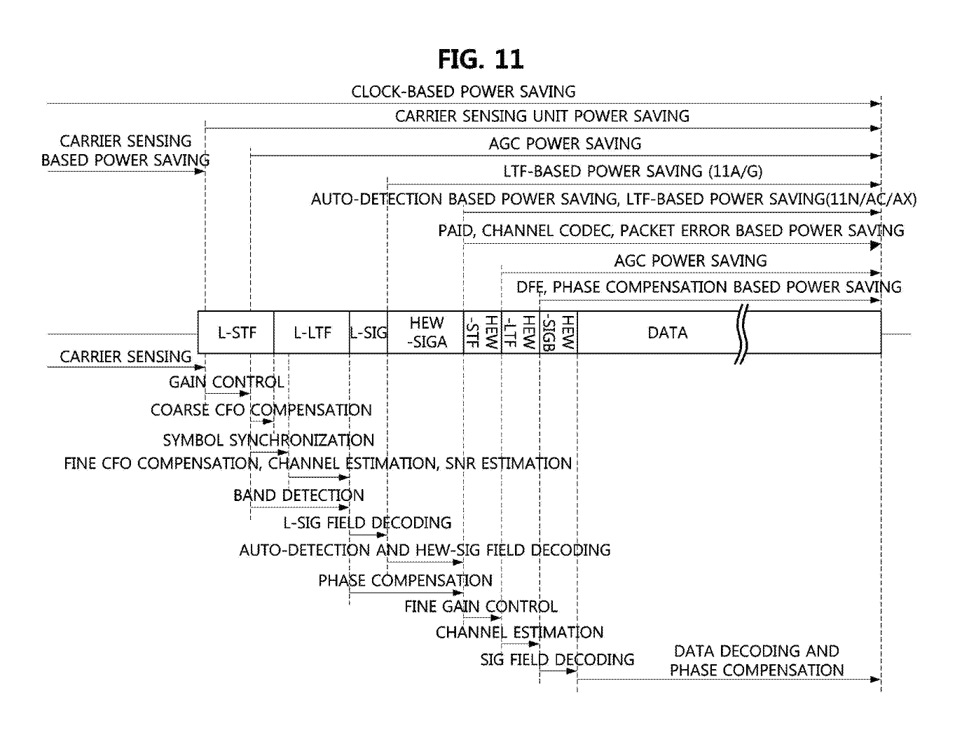

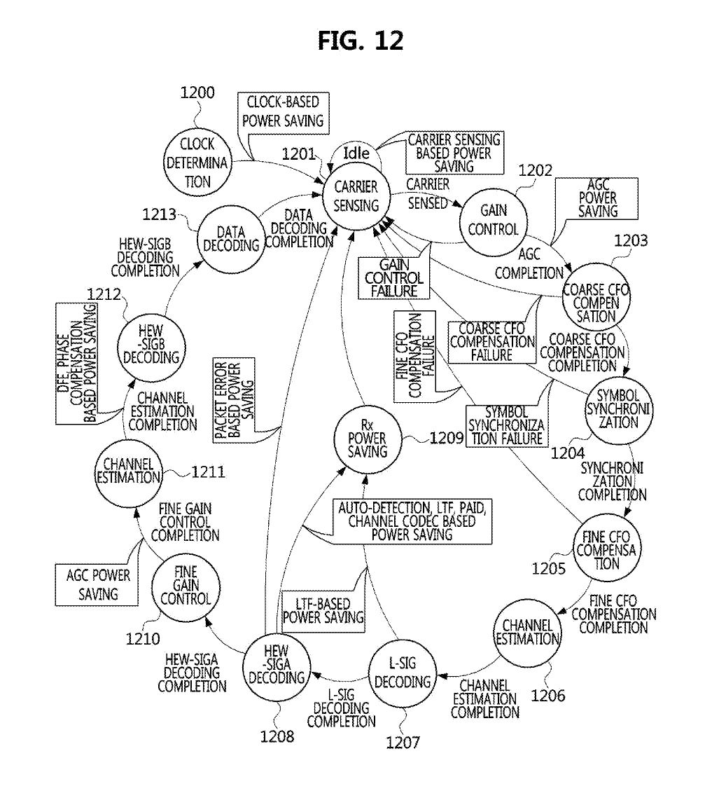

FIG. 11 is a conceptual diagram to explain power saving methods applied to respective reception states for a frame according to IEEE 802.11ax standard, and FIG. 12 is a state transition diagram to explain power saving methods applied to respective reception states for a frame according to IEEE 802.11ax standard.

Referring to FIG. 11 and FIG. 12, a frame according to IEEE 802.11ax may comprise a L-STF, a L-LTF, a L-SIG field, a HEW-SIGA field, a HEW-STF, a HEW-LTF, a HEW-SIGB field, and a data field. The HEW-SIGA field, the HEW-STF, the HEW-LTF, and the HEW-SIGB field may mean fields defined for communication systems according to IEEE 802.11ax standard.

Here, the power saving methods performed based on the L-STF, the L-LTF, the L-SIG field, the HEW-SIGA field, the HEW-STF, the HEW-LTF, the HEW-SIGB field, and the data field may be identical to corresponding methods explained by referring to FIG. 9 and FIG. 10. That is, the HEW-SIGA field corresponds to the HT-SIGA field (or, the VHT-SIGA field), and the HEW-STF corresponds to the HT-STF (or, the VHT-STF), and the HEW-LTF corresponds to the HT-LTF (or, the VHT-LTF), and the HEW-SIGB field corresponds to the HT-SIGB field (or, the VHT-SIGB field).

In the following descriptions, the example embodiments of the above-described power saving methods will be explained in detail. The power saving methods may be classified into clock-based power saving methods, methods through controlling sizes of gates (i.e. sizes of circuits being driven) for respective reception states, power saving methods in OFDMA or multi-user multiple-input multiple-output (MU-MIMO) transmission environment, and power saving methods according to WLAN standard version supported by an access point.

Hereinafter, the clock-based power saving methods will be explained.

If the power management unit 560 of the station 500 can have information on WLAN standard version (IEEE 802.11a/b/g/n/ac/ax), operation bandwidths, a center frequency, operation bands, and so on supported by an access point with which the station 500 is associated, it may configure an operation clock frequency of the station 500 based on the information.

For example, when the station 500 according to IEEE 802.11ac standard accesses the access point according to IEEE 802.11n standard, since the access point operates only in 20 MHz bandwidth or in 40 MHz bandwidth, the station 500 may not support 80 MHz bandwidth. Thus, the power management unit 560 of the station 500 according to IEEE 802.11ac standard may determine the clock frequency based on 40 MHz bandwidth not 80 MHz bandwidth, and configure the circuits included in the station 500 with the determined operation clock frequency. Here, the operation clock frequency configured by the power management unit 560 may be determined based on Nyquist rate for the corresponding operation bandwidth signals. Also, the operation clock frequency may be an oversampling frequency over the frequency determined based on Nyquist rate. Here, the power management unit 560 of the station 500 may enhance power consumption efficiency by configuring the operation clock frequency of the circuits based on the operation bandwidth of the access point with which the station 500 is associated.

The below table 4 represents operation bandwidths and clock frequencies configured according to WLAN standards.

TABLE 4

| Operation | | Clock frequencies according to WLAN standards | | | |
|---|---|---|---|---|---|
| Bandwidth | | 11 a | 11 n | 11 ac | |
| 20 | MHz | 40 MHz | 40 MHz | 40 | MHz |
| 40 | MHz | — | 80 MHz | 80 | MHz |
| 80 | MHz | — | — | 160 | MHz |
| 160 | MHz | — | — | 320 | MHz |

When the access point operates in 20 MHz bandwidth, the station 500 according to IEEE 802.11a/n/ac may set its operation clock frequency to 40 MHz, two times of its operation bandwidth. When the access point operates in 40 MHz bandwidth, the station 500 according to IEEE 802.11n/ac may set its operation clock frequency to 80 MHz, two times of its operation bandwidth. Meanwhile, since the station 500 according to IEEE 802.11a does not support 40 MHz bandwidth, the station 500 according to IEEE 802.11a cannot set its clock frequency to 80 MHz.

When the access point operates in 80 MHz bandwidth, the station 500 according to IEEE 802.11ac may set its operation clock frequency to 160 MHz, two times of its operation bandwidth. Meanwhile, since the station 500 according to IEEE 802.11a/n does not support 80 MHz bandwidth, the station 500 according to IEEE 802.11a/n cannot set its clock frequency to 160 MHz. When the access point operates in 160 MHz bandwidth, the station 500 according to IEEE 802.11ac may set its operation clock frequency to 320 MHz, two times of its operation bandwidth. Meanwhile, since the station 500 according to IEEE 802.11a/n does not support 160 MHz bandwidth, the station 500 according to IEEE 802.11a/n cannot set its clock frequency to 320 MHz.

The access point and the station according to IEEE 802.11ax may support bandwidths wider than represented in the table 4. For example, when the access point operates in 320 MHz, the station 500 may set its clock frequency to 640 MHz, two times of the operation bandwidth.

Hereinafter, among the clock-based power saving methods, power saving methods based on notification of capability-related information (hereinafter, referred to as “CIN based power saving methods”) will be explained. The power saving methods based on notification of capability-related information may be classified into three methods.

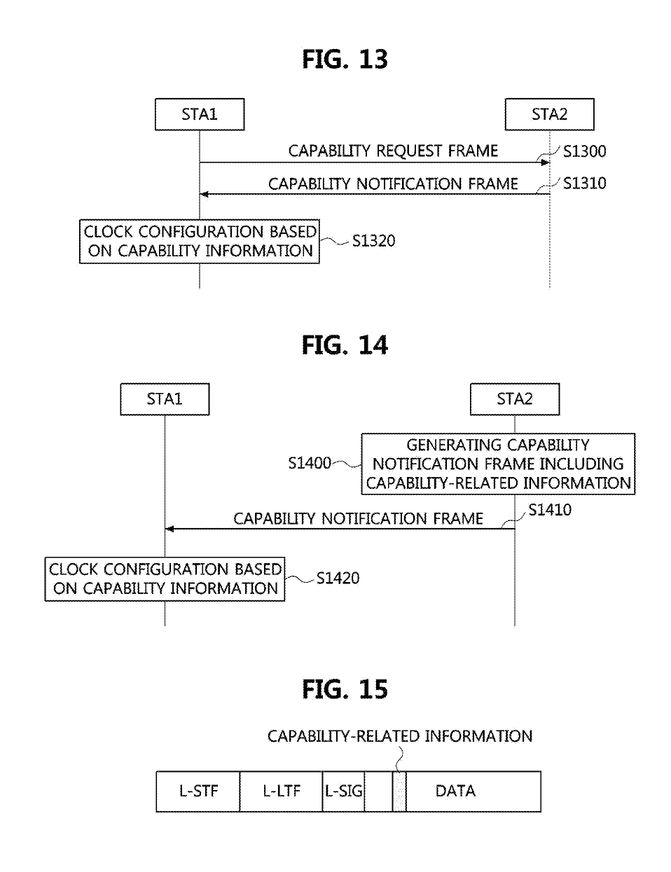

The first method is a method in which capability-related information of a station is obtained through exchange of a capability request frame and a capability notification frame between stations. Here, the capability notification frame is a response to the capability request frame, and the capability-related information may be included in the capability notification frame. At least one example embodiment of the first method will be explained in detail by referring to FIG. 13.

The second method is a method in which capability-related information of a station is obtained from the capability-notification frame. Here, the capability-related information may be included in the capability notification frame. The difference of the second method from the first method is that the capability-related information may be obtained from the capability notification frame without exchanging the capability request frame and the capability notification frame. At least one example embodiment of the second method will be explained in detail by referring to FIGS. 14 to 17.

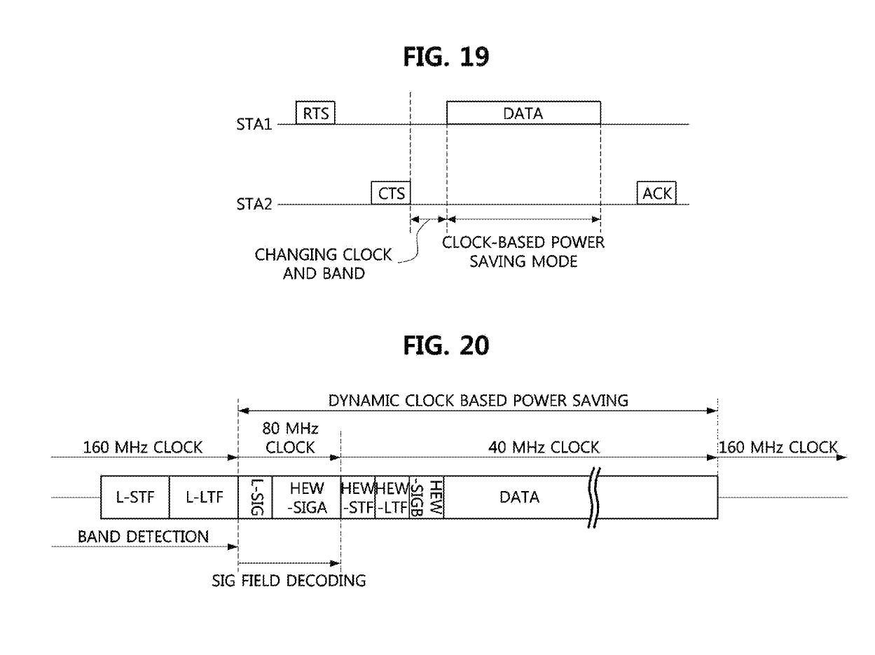

The third method is a method in which capability-related information of a station is obtained through exchange of the capability request frame and the capability notification frame between stations. Here, the capability notification frame is a response to the capability request frame, and the capability-related information may be included in both the capability request frame and the capability notification frame. The difference of the third method from the first method is that the capability-related information may be included in both the capability request frame and the capability notification frame. At least one example embodiment of the third method will be explained in detail by referring to FIG. 18 and FIG. 19.

Here, the capability-related information may include at least one of capability information of the station and an indicator indicating notification of capability information. Here, the capability information of the station may include information on at least one of WLAN standard version, operation bandwidths, a center frequency, and operation bands supported by the corresponding station.

FIG. 13 is a flow chart illustrating a clock-based power saving method according to an example embodiment of the present invention.

Referring to FIG. 13, a first station STA1 may mean an AP STA or a non-AP STA, and a second station STA2 may mean a non-AP STA or an AP STA. The first station STA1 may generate a capability request frame requesting capability information of the second station STA2, and transmit the generated capability request frame to the second station STA2 (S1300).

When the capability request frame is received, the second station STA2 may generate a capability notification frame including capability-related information. The capability-related information may include capability information of the second station STA2. The capability information of the second station STA2 may include at least one of WLAN standard version (e.g. IEEE 802.11a/b/g/n/ac/ax, and so on), operation bandwidths (e.g. 20 MHz, 40 MHz, 80 MHz, and so on), a center frequency, and operation bands supported by the second station. Here, the operation bands may indicate which bands are used among a plurality of bands, and may be represented as a bitmap or a set of band indexes. The second station STA2 may transmit the capability notification fame including the capability-related information to the first station STA1 (S 1310).

When the capability notification frame in response to the capability request frame, the first station STA1 may configure its operation clock frequency based on the information included in the capability notification frame (S1320). That is, the first station STA1 may identify the operation bandwidth of the second station STA2 from the information (i.e. WLAN standard version, operation bandwidths, a center frequency, and operation bands supported by the second station) included in the capability notification frame, and determine its clock frequency to be two times of the operation bandwidth of the second station STA2. The first station STA1 may configure circuits included in it with the determined clock frequency. Here, the procedure of configuring circuits with the determined clock frequency may be performed by the power management unit 560 of the first station STA1.

Then, the first station STA1 may receive a frame from the second station STA2 at the configured clock frequency.

FIG. 14 is a flow chart illustrating a CIN based power saving method according to an example embodiment of the present invention.

Referring to FIG. 14, the first station STA1 may mean an AP STA or a non-AP STA, and the second station STA2 may mean a non-AP STA or an AP STA. The second station STA2 may generate a capability notification frame including capability-related information (S1400). Here, the capability-related information may include capability information of the second station STA2.

The capability information of the second station STA2 may include at least one of WLAN standard version, operation bandwidths, a center frequency, and operation bands supported by the second station STA2. Here, the operation bands may indicate which bands are used among a plurality of bands, and may be represented as a bitmap or a set of band indexes. The capability notification frame may be a data frame, a management frame, or a control frame according to IEEE 802.11 standards. The second station STA2 may transmit the capability notification frame including the capability-related information to the first station STA1 (S1410).

Hereinafter, a structure of the capability notification frame including the capability-related information will be explained.

FIG. 15 is a conceptual diagram illustrating an example embodiment of a capability notification frame including capability-related information according to the present invention.

Referring to FIG. 15, a frame for a legacy station may include a L-STF, a L-LTF, a L-SIG field, and a data field. The second station STA2 may configure the capability-related information in the data field of the frame for the legacy station.

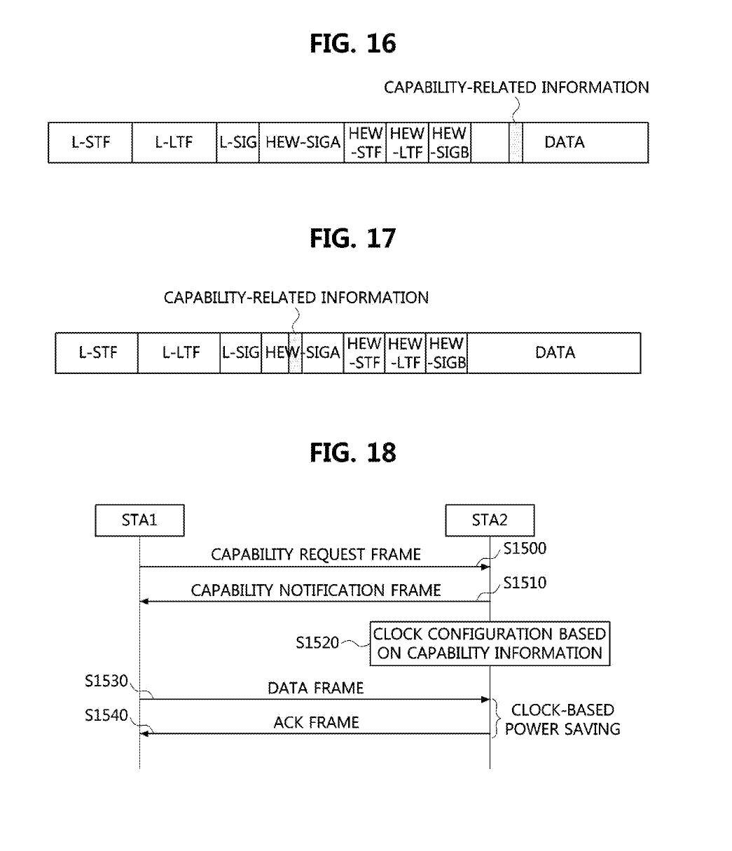

FIG. 16 is a conceptual diagram illustrating another example embodiment of a capability notification frame including capability-related information according to the present invention, and FIG. 17 is a conceptual diagram illustrating still another example embodiment of a capability notification frame including capability-related information according to the present invention.

Referring to FIG. 16 and FIG. 17, a frame according to IEEE 802.11ax standard may include a L-STF, a L-LTF, a L-SIG field, a HEW-SIGA field, a HEW-STF, a HEW-LTF, a HEW-SIGB field, and a data field. Here, the HEW-SIGA field, the HEW-STF, the HEW-LTF, and the HEW-SIGB field may mean specific fields defined for communication systems according to IEEE 802.11ax standard. The second station STA2 may configure the capability-related information in the data field of the frame according to IEEE 802.11ax standard. Alternatively, the second station STA2 may configure the capability-related information in the SIG field (e.g. the HEW-SIGA field or the HEW-SIGB field) of the frame according to IEEE 802.11ax standard.

Re-referring to FIG. 14, when the first station STA1 receives the capability notification frame including the capability-related information from the second station STA2, it may configure its operation clock frequency based on the capability-related information (S1420). That is, the first station STA1 can identify the operation bandwidth of the second station (STA2) based on the capability information (i.e. WLAN standard version, operation bandwidths, a center frequency, and operation bands supported by the second station STA2) of the second station STA2 included in the capability-related information.

The first station STA1 may determine its operation clock frequency to be two times of the operation bandwidth of the second station STA2. The first station STA1 may configure circuits included in it with the determined clock frequency. Here, the procedure for configuring the clock frequency may be performed by the power management unit 560 of the first station STA1. Then, the circuits included in the first station STA1 may operate based on the configured clock frequency.

FIG. 18 is a flow chart illustrating a CIN power saving method according to another example embodiment of the present invention, and FIG. 19 is a conceptual diagram to explain a CIN power saving method according to another example embodiment of the present invention.

Referring to FIG. 18 and FIG. 19, the first station STA1 may be an AP STA or a non-AP STA, and the second station STA2 may be a non-AP STA or an AP STA. The CIN power saving method may be performed in the following three ways.

The first way is that a station to transmit a data frame notifies capability information, and the second way is that a station to receive a data frame notifies capability information, and the third way is that both the station to transmit a data frame and the station to receive a data frame notify capability information. Another difference among the three ways is that types of information included in a capability request frame and a capability notification frame for respective ways are different from each other.

In the first way, the station to transmit a data frame notifies its capability information as explained below.

The first station STA1 may generate capability-related information including an indicator indicating notification of its capability information and the capability information, and transmit a capability request frame including the generated capability-related information to the second station STA2 (S1500). Here, the capability request frame may represent that the first station STA1 can support capability-related information notification based operation.

The capability information may include at least one of WLAN standard version, operation bandwidths, a center frequency, and operation bands which the first station STA1 supports for the second station STA2. The operation bands may indicate which bands are used among a plurality of bands, and may be represented as a bitmap or a set of band indexes. The capability request frame may be a control frame, a management frame, or a data frame. For example, the capability request frame may be a RTS frame of a PS-Poll frame.

The second station STA2 may receive the capability request frame from the first station STA1, and obtain the capability-related information (i.e. the indicator and the capability information) of the first station STA1 from the capability request frame. Based on the indicator, the second station STA2 may identify that the capability information of the first station STA1 is being notified, and may identify that the first station STA1 supports communications based on the WLAN standard version, the operation bandwidths, the center frequency, and the operation bands included in the capability information.

The second station STA2 may determine whether it can receive a frame or not based on the capability-related information included in the capability request frame. That is, the second station STA2 may determine whether it can support communications based on the WLAN standard version, the operation bandwidths, the center frequency, and the operation bands included in the capability information of the capability-related information. When the second station STA2 determines that it cannot receive a frame based on the capability information included in the capability request frame, the second station STA2 may not transmit a response to the capability request frame to the first station STA1.

On the contrary, if the second station STA2 determines that it can receive a frame based on the capability information included in the capability request frame, the second station STA2 may generate a capability notification frame including an indicator indicating this, and transmit the generated capability notification frame to the first station STA1 (S1510). Here, the capability notification frame may be a control frame, a management frame, or a data frame. For example, the capability notification frame may be a CTS frame.

In response to the capability request frame, the second station STA2 may transmit the capability notification frame to the first station STA1, and then configure its operation clock frequency based on the capability-related information included in the capability request frame (S1520). That is, since the second station STA2 can identify the operation bandwidth of the first station STA1 based on the capability information of the capability-related information, it may determine its operation clock frequency to be two times of the operation bandwidth of the first station STA1. The second station STA2 may configure its circuits with the determined clock frequency.

For example, when the bit map indicating the operation bands is configured as “11100000,” it indicates that the operation bands which the first station STA1 supports for the second station STA2 are configured to be contiguous 60 MHz. Thus, the second station STA2 may configure its operation clock frequency to be 120 MHz, two times of 60 MHz. Alternatively, when the bitmap is configured as “10010000,” this indicates that the operation bands which the first station STA1 supports for the second station STA2 are configured as non-contiguous 40 MHz. Thus, the second station STA2 may identify that it should operate in at least 80 MHz bandwidth in order to support the non-contiguous 40 MHz, and configure its operation clock frequency to be 160 MHz, two times of 80 MHz. Here, the procedure for configuring the operation clock frequency may be performed by the power management unit 560 of the second station STA2.

On the other hand, the second station STA2 may determine an operation duration for which it operates at the configured clock frequency. For example, when the capability request frame is a RTS frame, the second station STA2 may determine the operation duration to be a time duration indicated by a duration field included in the RTS frame. When the capability notification frame is a CTS frame, the second station STA2 may determine the operation duration to be a time duration indicated by a duration field included in the CTS frame.

Also, the second station STA2 may configure its operation bands based on the capability-related information. That is, since the second station STA2 can know the operation bands of the first station STA1 based on the capability information of the capability-related information, it may configure its operation bands as corresponding to the operation bands of the first station STA1. Here, although it is explained that the S1520 is performed after the S1510, a performing sequence of the S1520 is not limited to the above explanation. That is, the S1520 may also be performed before the S1510.

When the first station STA1 receives the capability notification frame as the response to the capability request frame, the first station STA1 may transmit a data frame to the second station STA2 (S1530). That is, the first station STA1 may transmit the data frame to the second station STA2 by utilizing the capability information of the capability-related information such as the WLAN standard version, the operation bandwidths, the center frequency, and the operation bands supported by the second station STA2.

The second station STA2 may receive the data frame from the first station STA1 based on the configured clock frequency. When the data frame is received successfully, the second station STA2 may transmit an ACK frame to the first station STA1 (S1540). Through this, the second station STA2 may decrease its power consumption.

In the second way, the station to receive a data frame notifies its capability information as explained below.

The first station STA1 may generate capability-related information including an indicator indicating that it can support transmission based on notification of capability information, and transmit a capability request frame including the generated capability-related information to the second station STA2 (S1500). Here, the capability request frame may indicate that the first station STA1 can support operation based on notification of capability-related information. The capability request frame may be a control frame, a management frame, or a data frame. For example, the capability request frame may be a RTS frame or a PS-Poll frame.

The second station STA2 may receive the capability request frame from the first station STA1, and obtain the indicator from the capability request frame. That is, based on the indicator included in the capability request frame, the second station STA2 may identify that the first station STA1 can support transmission based on notification of capability information. In this case, in order to reduce power consumption, the second station STA2 may determine its operation bandwidth on the consideration of a battery status, life time, and so on.

The second station STA2 may generate capability-related information including an indicator indicating that its capability information is notified and the capability information, and transmit a capability notification frame including the generated capability-related information to the first station STA1 (S1510). The capability information may include at least one of WLAN standard version, operation bandwidths, a center frequency, and operation bands supported by the second station STA2. The operation bands may indicate which bands are used among a plurality of bands, and may be represented as a bitmap or a set of band indexes. The capability notification frame may be a control frame, a management frame, or a data frame. For example, the capability notification frame may be a CTS frame.

In response to the capability request frame, the second station STA2 may transmit the capability notification frame to the first station STA1, and then configure its operation clock frequency based on its capability (S1520). That is, the second station STA2 may determine its clock frequency to be two times of its operation bandwidth. The second station STA2 may configure circuits included in it based on the determined clock frequency. Here, the procedure for configuring the clock frequency may be performed by the power management unit 560 of the second station STA2.

Also, the second station STA2 may determine an operation duration for which it operates at the configured clock frequency. For example, when the capability request frame is a RTS frame, the second station STA2 may determine the operation duration to be a time duration indicated by a duration field included in the RTS frame. When the capability notification frame is a CTS frame, the second station STA2 may determine the operation duration to be a time duration indicated by a duration field included in the CTS frame. Here, although it is explained that the S1520 is performed after the S1510, a performing sequence of the S1520 is not limited to the above explanation. That is, the S1520 may also be performed before the S1510.

The first station STA1 may receive the capability notification frame as the response to the capability request frame from the second station STA2, and obtain the capability-related information (i.e. the indicator and the capability information) from the capability notification frame. Based on the indicator, the first station STA1 may identify that the capability information of the second station STA2 is being notified, and may identify that the second station STA2 supports communications based on the WLAN standard version, the operation bandwidths, the center frequency, and the operation bands included in the capability information.

The first station STA1 may transmit a data frame to the second station STA2 through the operation bands indicated by the capability information of the second station STA2 included in the capability notification frame (S1530).

For example, when the bit map representing the operation bands is configured as “11100000,” the first station STA1 can transmit the data frame to the second station STA2 through contiguous 60 MHz band. When the bitmap is configured as “10010000,” the first station STA1 may transmit the data frame to the second station STA2 through the non-contiguous 40 MHz band. The second station STA2 may receive the data frame transmitted from the first station STA1 at its operation clock frequency (i.e. the clock frequency of STA2 is 120 MHz, two times of 60 MHz when the bitmap is “11100000,” and the clock frequency of STA2 is 160 MHz, two times of 80 MHz when the bit map is “1001000”), and transmit an ACK frame to the first station STA1 when the data frame is received successfully (S1540). Through this, the second station STA2 may reduce its power consumption.

In the third way, the station to transmit a data frame and the station to receive a data frame notifies capability information as explained below.

The first station STA1 may generate capability-related information including an indicator indicating that its capability information is notified and the capability information, and transmit a capability request frame including the generated capability-related information to the second station STA2 (S1500). Here, the capability request frame may represent that the first station STA1 can support capability-related information notification based operation.

The capability information may include at least one of at least one WLAN standard version, at least one operation bandwidth, at least one center frequency, and at least one operation band supported by the first station STA1. The operation bands may indicate which bands are used among a plurality of bands, and may be represented as a bitmap or a set of band indexes. The capability request frame may be a control frame, a management frame, or a data frame. For example, the capability request frame may be a RTS frame of a PS-Poll frame.

The second station STA2 may receive the capability request frame from the first station STA1, and obtain the capability-related information (i.e. the indicator and the capability information) of the first station STA1 from the capability request frame. Based on the indicator, the second station STA2 may identify that the capability information of the first station STA1 is being notified, and may identify that the first station STA1 supports communications based on the WLAN standard version, the operation bandwidths, the center frequency, and the operation bands included in the capability information.

In order to reduce power consumption, the second station STA2 may select one of the at least one capability (i.e. at least one WLAN standard version, at least one operation bandwidth, at least one center frequency, and at least one operation band). For example, the second station STA2 may determine its operation bandwidth among the at least one operation bandwidths. The second station STA2 may generate capability-related information including an indicator indicating notification of capability information and the selected capability information, and transmit a capability notification frame including the generated capability-related information to the first station STA1 (S1510). The capability information may include at least one of WLAN standard version, operation bandwidths, a center frequency, and operation bands supported by the second station STA2.

The operation bands may indicate which bands are used among a plurality of bands, and may be represented as a bitmap or a set of band indexes. The capability notification frame may be a control frame, a management frame, or a data frame. For example, the capability notification frame may be a CTS frame. The capability information included in the capability notification frame may be configured within the capability information included in the capability request frame.

In response to the capability request frame, the second station STA2 may transmit a capability notification frame to the first station STA1, and then configure its operation clock frequency based on both the capability information included in the capability request frame and its capability (S1520). That is, the second station STA2 may determine its operation clock frequency to be two times of an operation bandwidth common for both of its operation bandwidths and operation bandwidths of the first station STA1. The second station STA2 may configure its circuits with the determined clock frequency. Here, the procedure for configuring the circuits may be performed by the power management unit 560 of the second station STA2.

Also, the second station STA2 may determine an operation duration for which it operates at the configured clock frequency. For example, when the capability request frame is a RTS frame, the second station STA2 may determine the operation duration to be a time duration indicated by a duration field included in the RTS frame. When the capability notification frame is a CTS frame, the second station STA2 may determine the operation duration to be a time duration indicated by a duration field included in the CTS frame. Here, although it is explained that the S1520 is performed after the S1510, a performing sequence of the S1520 is not limited to the above explanation. That is, the S1520 may also be performed before the S1510.

The first station STA1 may receive the capability notification frame as the response to the capability request frame from the second station STA2, and transmit a data frame to the second station STA2 (S1530). That is, the first station STA1 may transmit the data frame to the second station STA2 through bands indicated commonly by both the capability information included in the capability request frame and the capability information included in the capability notification frame.

The second station STA2 may receive the data frame from the first station STA1 based on the configured clock frequency. When the data frame is received successfully, the second station STA2 may transmit an ACK frame to the first station STA1 (S1540). Through this, the second station STA2 may reduce its power consumption.

Meanwhile, in the power saving method based on notification of capability-related information, the information included in the capability request frame (or, the capability notification frame) may be transmitted as included in a service field (i.e. a service field positioned before a data field) which is utilized as scrambling initialization bits. That is, at least one bit of the service field may be used for indicating notification of capability-related information.

Values of the service field for indicating respective channel modes (contiguous or non-contiguous) and operation bandwidths may be configured as shown in the below table 5. That is, the station which received the capability request frame (or, the capability notification frame) may identify channel mode and operation bandwidth of the counterpart station based on the below table 5. The below table 5 shows a case that a maximum operation bandwidth is 160 MHz.

TABLE 5

| Channel Mode | Bandwidth | Field value |
|---|---|---|
| Contiguous | 20 | 0 |
| | 40 | 1 |
| | 80 | 2 |
| | 160 | 3 |
| Non- | 20 + 20 | 4 |
| contiguous | 40 + 40 | 5 |
| | 80 + 80 | 6 |
| | 20 + 40 | 7 |
| | 20 + 80 | 8 |
| | 40 + 80 | 9 |

For contiguous channel mode, positions of operation bands may be represented with band indexes as shown in the below table 6. The below table 6 shows a case that a maximum operation bandwidth is 160 MHz.

TABLE 6

| Position of band | | Band index |
|---|---|---|
| 1^{st} 20 | MHz | 0 |
| 2^{nd} 20 | MHz | 1 |
| 3^{rd} 20 | MHz | 2 |
| 4^{th} 20 | MHz | 3 |
| 5^{th} 20 | MHz | 4 |
| 6^{th} 20 | MHz | 5 |
| 7^{th} 20 | MHz | 6 |
| 8^{th} 20 | MHz | 7 |

Meanwhile, when a frame is received, the power management unit 560 of the station 500 may configure its clock frequency based on characteristics of the receive frame. That is, since the power management unit 560 of the station 500 may identify a channel mode based on correlations and powers for respective bands of a preamble included in the frame, and identify operation bandwidth based on SIG fields included in the frame, it may configure its clock frequency based on the identified channel mode and operation bandwidth.

FIG. 20 is a conceptual diagram to explain a dynamic clock based power saving method according to an example embodiment of the present invention.

Referring to FIG. 20, the station 500 associated with an access point may operate at a default clock frequency in a reception standby mode. For example, in case that the station is associated with the access point supporting 20/40/80 MHz bandwidths, since the maximum bandwidth is 80 MHz, the station may configure its clock frequency to be 160 MHz, and operate at 160 MHz clock frequency.

When the station 500 receives a frame, it may detect an operation bandwidth based on a preamble included in the received frame, and re-configure its clock frequency for fields starting from the next field (i.e. the L-SIG field) based on the detected operation bandwidth. That is, if the station 500 determines that the operation bandwidth is 40 MHz after detecting preambles of the received frame in unit of 20 MHz, it may re-configure its clock frequency to be 80 MHz, two times of the operation bandwidth 40 MHz, and operate at 80 MHz clock frequency from the next field (L-SIG field).

After then, the station 500 may detect an operation bandwidth by decoding the SIG field of the received frame, and re-configure its clock frequency for fields starting from the next field (i.e. the HEW-STF) based on the detection result. That is, if the station 500 determines that the operation bandwidth is 20 MHz after decoding the HEW-SIGA field of the received frame, it may re-configure its clock frequency to be 40 MHz, and operate at 40 MHz clock frequency from the next field (the HEW-STF).

The station 500 may maintain its clock frequency configured based on the HEW-SIGA until processing on the received frame (that is, decoding a data field of the received frame) is completed, and change its clock frequency to the default clock frequency after completion of the processing on the received frame. That is, the station 500 may decode the data field at 40 MH clock frequency, and re-configure its clock frequency to be 160 MHz in order to support all bandwidths of the access point after processing the data field.

Hereinafter, a power saving method based on control of circuits according respective frame reception states will be explained.

Here, circuits included in the station 500 may mean respective configurations illustrated in FIGS. 5 to 7. The power saving methods based on control of gate sizes may include a carrier sensing based power saving method, an AGC based power saving method, an LTF based power saving method, a partial association ID (PAID) based power saving method, a channel codec based power saving method, a WLAN standard version based power saving method, a packet-error based power saving method, a fine AGC based power saving method, a DFE based power saving method, a phase compensation based power saving method, and so on.

The carrier sensing based power saving method will be described as follows. The power management unit 560 of the station 500 may control the carrier sensing unit 530 (i.e. the saturation-based carrier sensing unit 531, the correlation-based carrier sensing unit 532, and the energy-based carrier sensing unit 533) based on channel states. For example, the power management unit 560 of the station 500 may activate only the carrier sensing unit 530 during an idle listening period in which signals do not exist, and deactivate the carrier sensing unit 530 and activate other circuits during a busy period in which signals exist.

The AGC based power saving method will be described as follows. The power management unit 560 of the station 500 may activate the AGC 541-1-2 when signals are detected through carrier sensing. The activated AGC 541-1-2 may perform AGC based on the L-STF included in the frame. After completion of the AGC, the power management unit 560 of the station 500 may deactivate the AGC 541-1-2.

The L-LTF based power saving method will be described as follows. After completion of the AGC, the L-LTF based power saving method may be performed. The station 500 may determine whether to process the received frame based on the L-LTF included in the received frame. For example, the station 500 may calculate SNR using repetitive LTF symbols included in the L-LTF of the frame, and obtain information on transmission mode from the SIG field of the received frame. Thus, the station 500 may estimate possibility in success of frame decoding based on the calculated SNR and the transmission mode being used. If the possibility of decoding success is below a predetermined threshold value, fields to be received may not be decoded. That is, the power management unit 560 may deactivate circuits related to frame processing (i.e. the circuits used for receiving frame) until reception end point of the corresponding frame.

The PAID based power saving method will be described as follows. The station 500 may obtain a PAID from the SIG field of the frame. Then, if the obtained PAID does not match its PAID, the station may not decode fields following the SIG field (i.e. HT-STF (or, VHT-STF), HT-LTF (or, VHT-LTF), HT-SIGB (or, VHT-SIGB) field, and data field). That is, the power management unit 560 may deactivate circuits related to frame processing (i.e. circuits used for receiving the frame) until a reception end point of the corresponding frame when the PAIDs do not match each other.

The channel codec based power saving method will be described as follows. The power management unit 560 of the station 500 may control operation of the channel decoder according to type of channel coding indicated by the SIG field included in the received frame. Here, the channel decoder may include a Viterbi decoder, a LDPC decoder, and so on. For example, if the SIG field included in the frame indicates that used channel code is Viterbi code, the power management unit 560 of the station 500 may activate the Viterbi decoder and deactivate the LDPC decoder. On the contrary, if the SIG field included in the frame indicates that used channel code is LDPC code, the power management unit 560 of the station 500 may activate the LDPC decoder and deactivate the Viterbi decoder.

The WLAN standard version based power saving method will be described as follows. In the receiving end of the station 500, a receiving end for supporting IEEE 802.11b and a receiving end for supporting IEEE 802.11a/g/n/ac/ax (i.e. a receiving end supporting OFDM transceiving) may be implemented as separate engines, and they do not operate simultaneously. Thus, in case that a preamble and a SIG field included in the frame indicates that a current frame is a frame according to IEEE 802.11b standard, the power management unit 560 of the station 500 may activate the receiving end for supporting IEEE 802.11b and deactivate the receiving end for supporting OFDM transceiving.

On the contrary, in case that a preamble and a SIG field included in the frame indicates that a current frame is a frame according to IEEE 802.11a/g/n/ac/ax standards, the power management unit 560 may activate the receiving end for supporting OFDM transceiving and deactivate the receiving end for supporting IEEE 802.11b.

The packet-error based power saving method will be described as follows. When a cyclic redundancy check (CRC) error occurs in a HEW-SIG field of a frame according to IEEE 802.11ax, the station 500 may initialize a state machine and be transitioned to a carrier sensing state. In the case, the power management unit 560 of the station 500 may activate the carrier sensing unit 530 and deactivate other circuits.

The fine AGC based power saving method will be described as follows. The power management unit 560 of the station 500 may activate the AGC 541-1-2 before receiving a HEW-STF of a frame according to IEEE 802.11ax. The activated AGC 541-1-2 may perform AGC based on the HEW-STF, and store a gain control value and relevant parameters. After the AGC based on HEW-STF, the power management unit 560 of the station 500 may deactivate the AGC 541-1-2.

The DFE based power saving method will be described as follows. The power management unit 560 of the station 500 may deactivate a DFE processing the next time-domain sub-band while processing the data field of the frame. That is, the power management unit 560 of the station 500 may deactivate the channel mixer 541-2-1, the filter 541-2-2, the symbol synchronization detection unit 541-2-3, the auto-correlation detection unit 541-2-4, the cross-correlation detection unit 541-2-5, the CCA detection unit 541-2-6, the RSSI detection unit 541-2-7, and the CFO compensation unit 541-2-8 included in the time-domain sub-band DFE 541-2.

The phase compensation based power saving method will be described as follows. The power management unit 560 of the station 500 may control operation of the phase compensation unit 541-3-2. The power management unit 560 of the station 500 may activate the phase compensation unit 541-3-2 when the data field included in the frame is decoded. The activated phase compensation unit 541-3-2 may estimate a phase error based on a small number of pilot signals, and stabilize the phase error through noise filtering by using a loop filter.

After stabilization of the phase error, in order to reduce power consumption due to complex computations, the power management unit 560 of the station 500 may deactivate the phase compensation unit 541-3-2, or may control operation of the phase compensation unit 541-3-2 to periodically wake and compensate the phase error. For example, if a length of the frame is equal to or shorter than a predefined length, the power management unit 560 of the station 500 may deactivate the phase compensation unit 541-3-2 from a time that the phase error is stabilized until a reception end point of the frame. On the contrary, if the length of the frame is longer than a predefined length, the power management unit 560 of the station 500 may control operation of the phase compensation unit 541-3-2 to perform the phase error compensation.

Hereinafter, power saving methods in OFDMA or MU-MIMO transmission environment will be described.

When a communication system operates in a downlink OFDMA manner or in a downlink MU-MIMO manner, lengths of actual data fields (i.e. data field excluding padding parts) transmitted to respective stations may be different. In this case, each station may operate in power saving mode from a reception end point of the actual data field included in a frame for it until a reception end point of the frame. At this time, the station 500 may operate in doze mode for power saving, or operate in power saving state of awake mode.

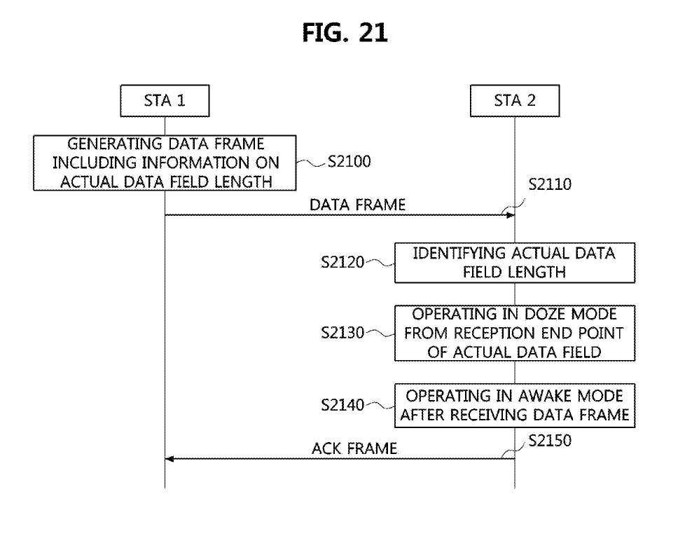

FIG. 21 is a flow chart illustrating a power saving method for each station according to an example embodiment of the present invention.

Referring to FIG. 21, the first station STA1 may be an AP STA or a non-AP STA, and the second station STA2 may be a non-AP STA or an AP STA. Here, the first station STA1 may transmit a data frame in the downlink OFDMA manner or in the downlink MU-MIMO manner. The first station STA1 may generate power saving information including length information of an actual data field in a data frame to be transmitted, and generate the data frame including the power saving information (S2100).

The power saving information may be divided into common power saving information and station-specific power saving information. The common power saving information may mean power saving information provided commonly to all stations. For example, the common power saving information may include station identifiers or at least one group identifier indicating stations to receive the frame based on the downlink OFDMA manner or the downlink MU-MIMO manner. Also, the common power saving information may further include at least one of an indicator indicating operation of station-specific power saving mode and at least one type of used power saving mode (e.g. station-specific power saving mode, clock-based power saving mode, and so on).

The station-specific power saving information may mean power saving information provided to each station. For example, the station-specific power saving information may include at least one of a station identifier and information on the length of actual data field. Also, the station-specific power saving information may further include at least one of operation bandwidths, a center frequency, operation bands and modulation and coding scheme (MCS) of the first station STA1.

The first station STA1 may generate a SIG field including the power saving information, and generate a data frame including the generated SIG field. The first station STA1 may transmit the data frame including the power saving information to the stations in the OFDMA manner or MU-MIMO manner (S2110). On the receipt of the data frame, the second station STA2 may obtain the power saving information (i.e. the common power saving information and the station-specific power saving information) included in the SIG field of the received data frame.

When the second station STA2 obtains the common power saving information, the second station STA2 may determine whether the station identifier (or, the group identifier) included in the common power saving information matches its identifier or not. If its identifier matches the station identifier (or, the group identifier) included in the common power saving information, the second station STA2 may receive fields following the SIG field. On the contrary, if its identifier does not match the station identifier (or, the group identifier) included in the common power saving information, the second station STA2 may not receive the fields following the SIG field. In this case, the power management unit 560 of the second station STA2 may deactivate all circuits included in the receiving end until a transmission end point of the corresponding frame.

The second station STA2 may identify the length of actual data field included in the frame based on the station-specific power saving information (S2120). Also, the second station STA2 may identify an operation bandwidth of the first station STA1 based on the station-specific power saving information, determined its clock frequency to be two times of the operation bandwidth, and configure circuits included in it with the determined clock frequency. Here, the procedure for configuring the circuits with the determined clock frequency may be performed by the power management unit 560 of the second station STA2.

Then, the second station STA2 may receive the actual data field included in the data frame. At this time, if a reception end point of the actual data field is earlier than a reception end point of the data frame, the second station STA2 may operate in power saving mode (i.e. a doze mode or a power saving mode in awake mode) from the reception end point of the actual data field to the reception end point of the data frame (S2130). After the reception end point of the data frame, the second station STA2 may be transitioned from the power saving mode to the awake mode (S2140), and transmit an ACK frame to the first station STA1 in response to the received data frame (S2150).

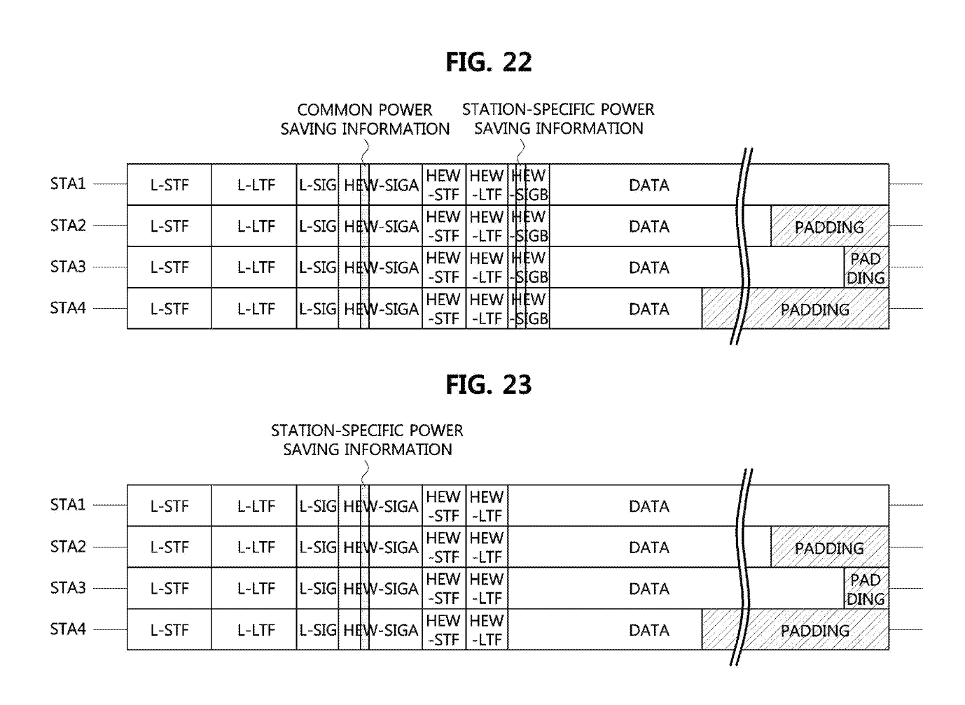

FIG. 22 is a conceptual diagram illustrating an example embodiment of a data frame including power saving information.

Referring to FIG. 22, the access point may transmit a data frame to stations STA1, STA2, STA3, and STA4 in the downlink OFDMA manner or the downlink MU-MIMO manner. The data frame may include a L-STF, a L-LTF, a L-SIG field, a HEW-SIGA field, a HEW-STF, a HEW-LTF, a HEW-SIGB field, and a data field. The HEW-SIGA field, the HEW-STF, the HEW-LTF, and the HEW-SIGB field may mean fields defined for a communication system according to IEEE 802.11ax standard.

The access point may generate the HEW-SIGA field as including common power saving information, and generate the HEW-SIGB field as including station-specific power saving information. The common power saving information may include at least one of station identifiers (or, at least one group identifier) indicating stations to receive the frame based on the downlink OFDMA manner or the downlink MU-MIMO manner, an indicator indicating operation of station-specific power saving mode and at least one type of used power saving mode (e.g. station-specific power saving mode, clock-based power saving mode, and so on). The station-specific power saving information may include at least one of length information of actual data field, operation bandwidth of the access point, a center frequency, operation bands, and MCS information.

On the basis of the station-specific power saving information, the first station STA1 may identify that a reception end point of the actual data field is identical to a reception end point of the data frame. Thus, the first station STA1 does not operate in power saving mode (i.e. a doze mode or a power saving state of awake mode) from the reception end point of the actual data field to the reception end point of the data frame. On the contrary, based on the station-specific power saving information, the stations STA2, STA3, and STA4 may identify that the reception end point of the actual data field is earlier than the reception end point of the data frame. Therefore, the stations STA2, STA3, and STA4 may operate in power saving mode (or, a doze mode or a power saving state of awake mode) from the reception end point of the actual data field to the reception end point of the data frame.

FIG. 23 is a conceptual diagram illustrating another example embodiment of a data frame including power saving information.

Referring to FIG. 23, the access point may transmit a data frame to stations STA1, STA2, STA3, and STA4 in the downlink OFDMA manner or the downlink MU-MIMO manner. The data frame may include a L-STF, a L-LTF, a L-SIG field, a HEW-SIGA field, a HEW-STF, a HEW-LTF, a HEW-SIGB field and a data field. The HEW-SIGA field, the HEW-STF, the HEW-LTF, and the HEW-SIGB field may mean fields defined for a communication system according to IEEE 802.11ax standard.

The access point may generate the HEW-SIGA field as including station-specific power saving information. The station-specific power saving information may include at least one of length information of actual data field, operation bandwidth of the access point, a center frequency, operation bands, MCS information, an indicator indicating operation of station-specific power saving mode, information on used power saving mode, and a station identifier (or, a group identifier).

On the basis of the station-specific power saving information, the first station STA1 may identify that a reception end point of the actual data field is identical to a reception end point of the data frame. Thus, the first station STA1 does not operate in power saving mode (i.e. a doze mode or a power saving state of awake mode) from the reception end point of the actual data field to the reception end point of the data frame. On the contrary, based on the station-specific power saving information, the stations STA2, STA3, and STA4 may identify that the reception end point of the actual data field is earlier than the reception end point of the data frame. Therefore, the stations STA2, STA3, and STA4 may operate in power saving mode (or, a doze mode or a power saving state of awake mode) from the reception end point of the actual data field to the reception end point of the data frame.

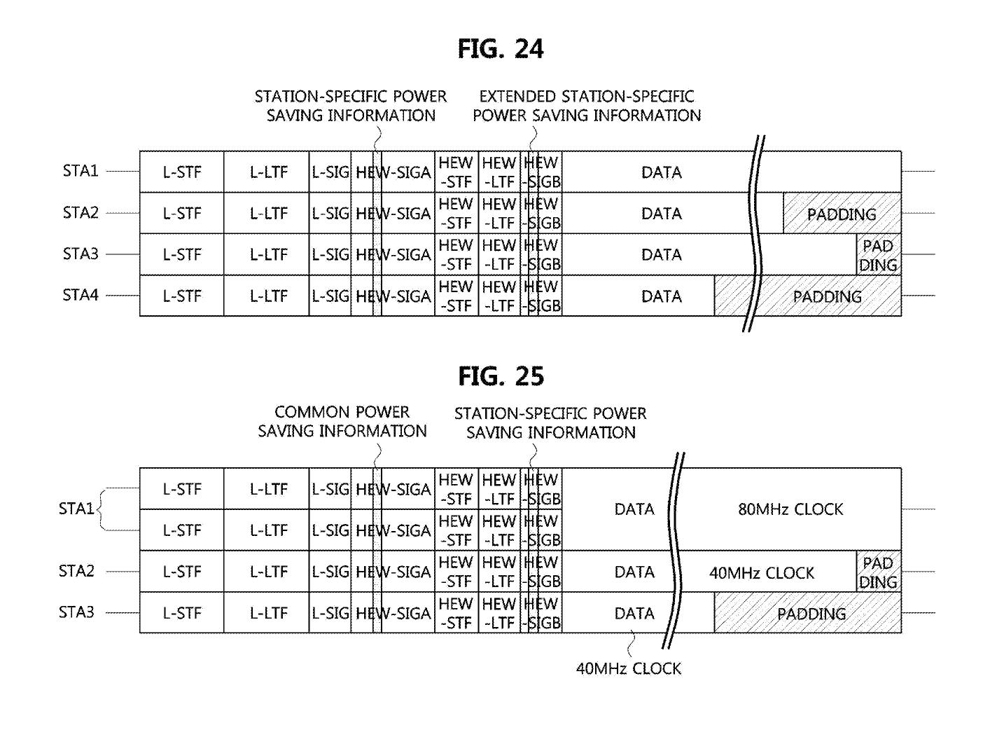

FIG. 24 is a conceptual diagram illustrating still another example embodiment of a data frame including power saving information.

Referring to FIG. 24, the access point may transmit a data frame to the stations STA1, STA2, STA3, and STA4 in the downlink OFDMA manner or the downlink MU-MIMO manner. The data frame may include a L-STF, a L-LTF, a L-SIG field, a HEW-SIGA field, a HEW-STF, a HEW-LTF, a HEW-SIGB field and a data field. The HEW-SIGA field, the HEW-STF, the HEW-LTF, and the HEW-SIGB field may mean fields defined for a communication system according to IEEE 802.11ax standard.

The access point may generate the HEW-SIGA field as including station-specific power saving information, and generate the HEW-SIGB field as including extended station-specific power saving information. The station-specific power saving information and the extended power saving information may include the same information. For example, the station-specific power saving information (or, the extended station-specific power saving information) may include at least one of length information of actual data field, operation bandwidth of the access point, a center frequency, operation bands, MCS information, an indicator indicating operation of station-specific power saving mode, information on used power saving mode, and a station identifier (or, a group identifier).

Alternatively, the station-specific power saving information and the extended power saving information may include different information. For example, the station-specific power saving information may include only the length information of actual data field, and the extended station-specific power saving information may include other information except the length information of actual data field.

On the basis of the station-specific power saving information (or, the extended station-specific power saving information), the first station STA1 may identify that a reception end point of the actual data field is identical to a reception end point of the data frame. Thus, the first station STA1 does not operate in power saving mode (i.e. a doze mode or a power saving state of awake mode) from the reception end point of the actual data field to the reception end point of the data frame. On the contrary, based on the station-specific power saving information (or, the extended station-specific power saving information), the stations STA2, STA3, and STA4 may identify that the reception end point of the actual data field is earlier than the reception end point of the data frame. Therefore, the stations STA2, STA3, and STA4 may operate in power saving mode (or, a doze mode or a power saving state of awake mode) from the reception end point of the actual data field until the reception end point of the data frame.

FIG. 25 is a conceptual diagram to explain a clock based power saving method using the data frame including power saving information.

Referring to FIG. 25, the access point may transmit a data frame to the stations STA1, STA2, and STA3 in the downlink OFDMA manner or the downlink MU-MIMO manner. The data frame may include a L-STF, a L-LTF, a L-SIG field, a HEW-SIGA field, a HEW-STF, a HEW-LTF, a HEW-SIGB field and a data field. The HEW-SIGA field, the HEW-STF, the HEW-LTF, and the HEW-SIGB field may mean fields defined for a communication system according to IEEE 802.11ax standard.

The access point may generate the HEW-SIGA field as including common power saving information, and generate the HEW-SIGB field as including station-specific power saving information. The common power saving information may include at least one of station identifiers (or, at least one group identifier) indicating stations to receive the frame based on the downlink OFDMA manner or the downlink MU-MIMO manner, an indicator indicating operation of station-specific power saving mode and at least one type of used power saving mode (e.g. station-specific power saving mode, clock-based power saving mode, and so on). The station-specific power saving information may include at least one of length information of actual data field, operation bandwidth of the access point, a center frequency, operation bands, and MCS information.

Alternatively, the access point may generate the HEW-SIGA field as including the station-specific power saving information, and generate the HEW-SIGB field as including extended station-specific power saving information. The station-specific power saving information and the extended power saving information may include the same information.

For example, the station-specific power saving information (or, the extended station-specific power saving information) may include at least one of length information of actual data field, operation bandwidth of the access point, a center frequency, operation bands, MCS information, an indicator indicating operation of station-specific power saving mode, information on used power saving mode, and a station identifier (or, a group identifier).

Alternatively, the station-specific power saving information and the extended power saving information may include different information. For example, the station-specific power saving information may include only the length information of actual data field, and the extended station-specific power saving information may include other information except the length information of actual data field.

On the basis of the station-specific power saving information (or, the extended station-specific power saving information), the first station STA1 may identify that the operation bandwidth of the access point is 40 MHz, and thus configure its clock frequency to be 80 MHz, two times of the operation bandwidth. Also, the first station STA1 may identify that a reception end point of the actual data field is identical to a reception end point of the data frame. Thus, the first station STA1 may receive the data field at 80 MHz clock frequency, and does not operate in power saving mode (i.e. a doze mode or a power saving state of awake mode) from the reception end point of the actual data field to the reception end point of the data frame.

On the contrary, based on the station-specific power saving information (or, the extended station-specific power saving information), the stations STA2 and STA3 may identify that the operation bandwidth of the access point is 20 MHz, and thus configure its m clock frequency to be 40 MHz, two times of the operation bandwidth. Also, the stations STA2 and STA3 may identify that the reception end point of the actual data field is earlier than the reception end point of the data frame. Therefore, the stations STA2 and STA3 may receive the data field at 40 MHz clock frequency, and operate in power saving mode (or, a doze mode or a power saving state of awake mode) from the reception end point of the actual data field until the reception end point of the data frame.

On the other hand, the above-described power saving method based on notification of capability information may be applied to a communication system supporting the downlink OFDMA manner or the downlink MU-MIMO manner.

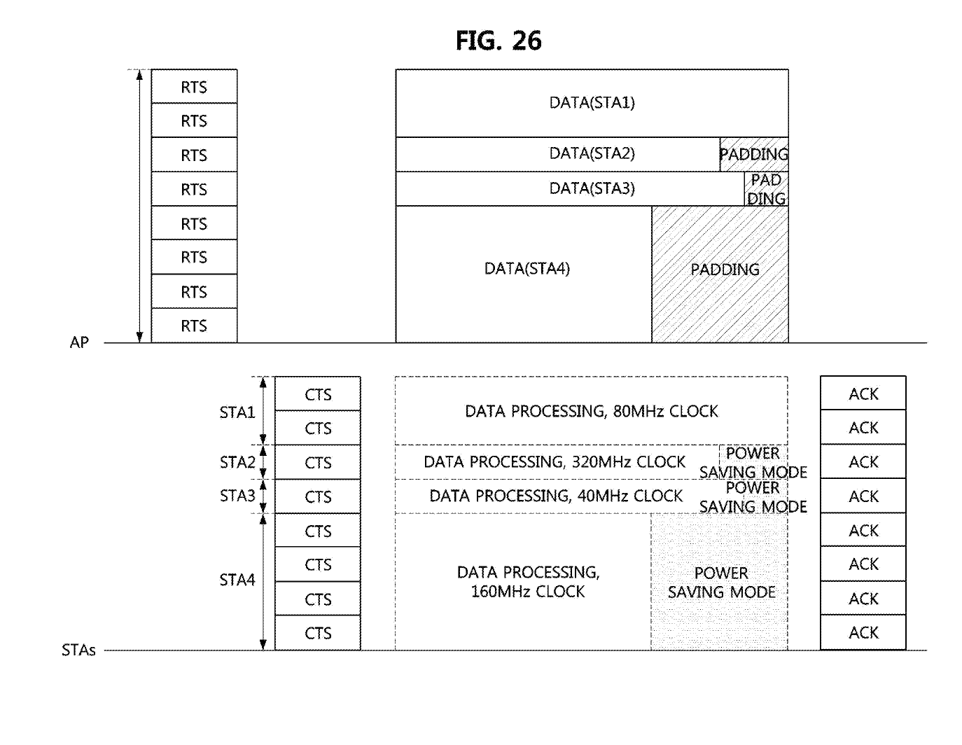

FIG. 26 is a conceptual diagram to explain a station-specific power saving method according to another example embodiment of the present invention.

Referring to FIG. 26, the access point AP may transmit a capability request frame to the stations STA1, STA2, STA3, and STA4 in the downlink OFDMA manner of the downlink MU-MIMO manner. The capability request frame may be a control frame, a management frame, or a data frame. For example, the capability request frame may be a RTS frame.

In response to the capability request frame, each of the stations STA1, STA2, STA3, and STA4 may transmit a capability notification frame to the access point AP. The capability notification frame may also be a control frame, a management frame, or a data frame. For example, the capability notification frame may be a CTS frame.

Here, the transmission procedures for the capability request frame and the capability notification frame may be performed based on the CIN based power saving method which was explained by referring to FIG. 18 and FIG. 19. For reference, a difference between the CIN based power saving method illustrated in FIG. 18 and FIG. 19 and the power saving method illustrated in FIG. 26 is that the capability request frame used in the station-specific power saving method further includes length information of actual data field included in a data frame (i.e. a data frame to be transmitted after exchanging the capability request frame and the capability notification frame).

That is, in a first way in which a station to transmit the data frame notifies capability information, the capability request frame may include an indicator indicating notification of capability information, the capability information, and the length information of actual data field included in the frame. The capability information may include at least one of WLAN standard version, operation bandwidths, a center frequency, and operation bands supported by the access point. The capability notification frame may include an indicator indicating that the data frame can be received based on the capability information included in the capability request frame.

In a second way in which a station to receive the data frame notifies capability information, the capability request frame may include an indicator indicating that the station supports transmission based on notification of capability information and the length information of actual data field included in the frame. The capability notification frame may include an indicator indicating that the capability information is notified and the capability information. Here, the capability information may include at least one of WLAN standard version, operation bandwidths, a center frequency, and operation bands supported by each of the stations STA1, STA2, STA3,and STA4.

In a third way in which both of the station to transmit a data frame and the station to receive a data frame notify capability information, the capability request frame may include an indicator indicating that the capability information is notified, the capability information, and the length information of actual data field included in the frame. The capability information in the capability request frame may include at least one of WLAN standard version, operation bandwidths, a center frequency, and operation bands supported by the access point. The capability notification frame may include an indicator indicating that the capability information is notified and the capability information. Here, the capability information included in the capability notification frame may include at least one of WLAN standard version, operation bandwidths, a center frequency, and operation bands supported by each of the stations STA1, STA2, STA3, and STA4.

In FIG. 26, it is presumed that the access point AP and stations STA1, STA2, STA3, and STA4 operate based on the second way. The access point AP may transmit a capability request frame to the stations STA1, STA2, STA3, and STA4 in the downlink OFDMA manner or in the downlink MU-MIMO manner, wherein the capability request frame includes an indicator indicating that the station supports transmission based on notification of capability information and the length information of actual data field included in the frame.

On the receipt of the capability request frame, the first station STA1 may generate a capability notification frame including an indicator indicating that capability information is notified and the capability information (40 MHz operation bandwidth, band indexes {0,1}, and so on). Here, the band indexes {k1, k2} may indicate that k1-th band and k2-th band are allocated. Then, the first station may transmit the generated capability notification frame to the access point AP in response to the capability request frame.

The second station STA2 which does not support the power saving method based on notification of capability information may simply transmit a capability notification frame to the access point AP in response to the capability request frame. In this case, the capability notification frame does not include the above-described information such as the indicator indicating that the capability information is notified and the capability information (i.e. WLAN standard version, operation bandwidths, a center frequency, and operation bands supported by the second station STA2).

On the receipt of the capability request frame, the third station STA3 may generate a capability notification frame including an indicator indicating notification of capability information, 20 MHz operation bandwidth, band index {3}, and so on. In response to the capability request frame, the third station STA3 may transmit the generated capability notification frame to the access point AP.

On the receipt of the capability request frame, the fourth station STA4 may generate a capability notification frame including an indicator indicating notification of capability information, 80 MHz operation bandwidth, band indexes {4,5,6,7}, and so on. Then, the fourth station STA4 may transmit the generated capability notification frame to the access point AP.

Here, the stations STA1, STA2, STA3, and STA4 may transmit their capability notification frames to the access point AP as multiplexed in OFDMA manner.

The access point having received the capability notification frames may transmit data frames to the stations STA1, STA2, STA3, and ST4 based on the information included in the capability notification frames. For example, the access point may transmit a data frame to the first station STA1 by using 40 MHz operation bandwidth and operation bands indicated by the set of band indexes {0,1}. Also, the access point may transmit a data frame to the second station STA3 by using 20 MHz operation bandwidth and operation bands indicated by the set of band indexes {3}. Also, the access point may transmit a data frame to the fourth station STA4 by using 80 MHz operation bandwidth and operation bands indicated by the set of band indexes {4,5,6,7}. Meanwhile, since capability information of the second station STA2 was not notified, the access point may transmit a data frame to the second station STA2 within operation bands which the access point is able to support.

The stations STA1, STA2, STA3, and STA4 may receive the data frames transmitted from the access point. In this case, the first station STA1 may identify that a reception end point of actual data field is identical to a reception end point of the data frame for it, so that the first station STA1 may configure its clock frequency to be 80 MHz, two times of the operation bandwidth based on the information included in the capability notification frame. Thus, the first station STA1 may receive the data frame for it at 80 MHz clock frequency, and does not operate in power saving mode (i.e. a doze mode or a power saving state of awake mode) from the reception end point of actual data field until the reception end point of the data frame.

On the basis of the information included in the capability request frame, the second station STA2 may identify that a reception end point of actual data field is earlier than a reception end point of the data frame for it. Thus, the second station STA2 may configure its clock frequency to be 320 MHz, two times of the operation bandwidth which the access point is able to support, and operate in power saving mode (i.e. a doze mode or a power saving state of awake mode) from the reception end point of actual data field until the reception end point of the data frame.

Also, the third station STA3 may identify, based on the information of the capability request frame, that a reception end point of actual data field is earlier than a reception end point of the data frame for it, and configure its clock frequency to be 40 MHz, two times of the operation bandwidth based on the information included in the capability notification frame. Thus, the third station STA3 may receive the data frame for it at 40 MHz clock frequency, and may operate in power saving mode (i.e. a doze mode or a power saving state of awake mode) from the reception end point of actual data field until the reception end point of the data frame.

Also, the fourth station STA4 may identify, based on the information of the capability request frame, that a reception end point of actual data field is earlier than a reception end point of the data frame for it, and configure its clock frequency to be 160 MHz, two times of the operation bandwidth based on the information included in the capability notification frame. Thus, the fourth station STA4 may receive the data frame for it at 160 MHz clock frequency, and may operate in power saving mode (i.e. a doze mode or a power saving state of awake mode) from the reception end point of actual data field until the reception end point of the data frame.

The stations STA1, STA2, STA3, and STA4 having successfully received respective frames may transmit respective ACK frames to the access point AP in OFDMA manner.

Hereinafter, a power saving method according to WLAN standard version supported by an access point will be explained. The station 500 may determine, based on a phase modulation of a SIG field included in a frame received from the access point, one of which the received frame is a frame according to IEEE 802.11a, a frame according to IEEE 802.11n, or a frame according to IEEE 802.11ac. Also, the station 500 may determine whether the received frame is a frame according to IEEE 802.11ax based on the SIG field or additional bits indicating a transmission mode being used included in the received frame.

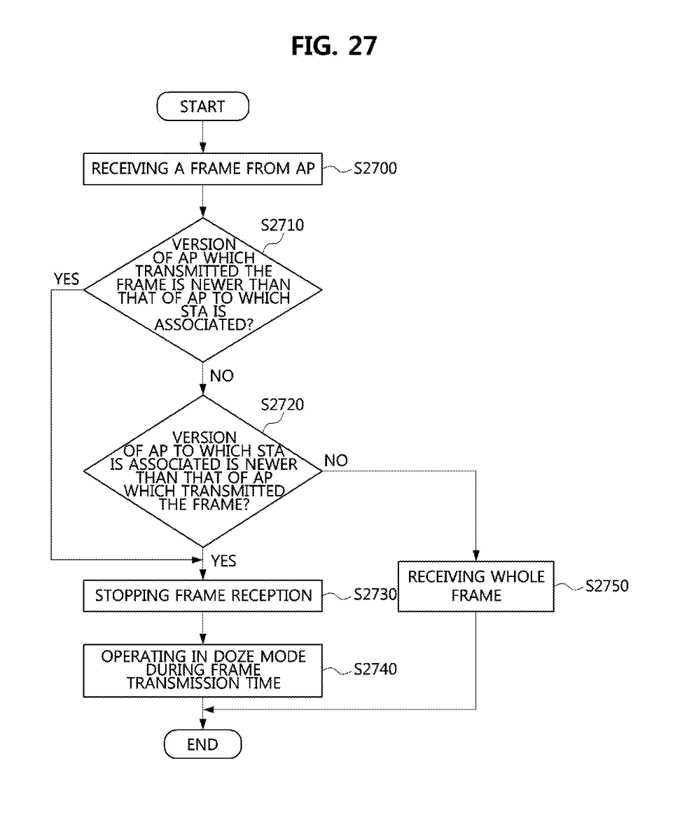

FIG. 27 is a flow chart illustrating a power saving method based on WLAN standard version supported by an access point according to an example embodiment of the present invention.

Referring to FIG. 27, the station 500 may receive a frame from an access point, and identify a SIG field of the frame (S2700). The station 500 may determine, based on a phase modulation of the SIG field, whether an IEEE 802.11 standard version supported by the access point transmitting the frame is newer or older than an IEEE 802.11 standard version supported by an access point with which the station 500 is currently associated (S2710).

For example, in case that the IEEE 802.11 standard version (e.g. IEEE 802.11ac) supported by the access point transmitting the frame is newer than the IEEE 802.11 standard version (e.g. IEEE 802.11n) supported by the access point with which the station is currently associated, the station 500 may stop reception of the frame (i.e. the fields following the SIG field), and may operate in power saving mode (i.e. a doze mode or a power saving state of awake mode) during the frame transmission time (S2730 and S2740).

Meanwhile, in case that the IEEE 802.11 standard version (e.g. IEEE 802.11ac) supported by the access point with which the station is currently associated is newer than the IEEE 802.11 standard version (e.g. IEEE 802.11n) supported by the access point transmitting the frame, the station 500 may stop reception of the frame (i.e. the fields following the SIG field), and may operate in power saving mode (i.e. a doze mode or a power saving state of awake mode) during the frame transmission time (S2730 and S2740).

On the other hand, in case that the IEEE 802.11 standard version supported by the access point with which the station is currently associated is identical to the IEEE 802.11 standard version supported by the access point transmitting the frame, the station 500 may receive the frame (i.e. the fields following the SIG field) (S2750).

Among capability-related frames described in the example embodiments of the present invention, the capability request frame and the capability notification frame may be a control frame, a management frame, or a data frame.

When the capability-related frames are management frames, the capability request frame and the capability notification frame may be a request frame and a response frame defined in IEEE 802.11ac as shown in the table 1. For example, the capability request frame and the capability notification frame may be an association request frame and an association response frame, respectively. Alternatively, if the capability notification frame is not a response frame to the capability request frame, the capability notification frame may be a beacon frame.

When the capability-related frames are control frames, the capability request frame and the capability notification frame may be a RTS frame and a CTS frame, respectively, as shown in the table 2.

The capability request frame and the capability notification frame may be defined as a new control frame or a new management frame. In this case, for identifying the capability request frame and the capability notification frame, reserved field values in IEEE 802.11ac standard may be used.

The example embodiments of the present invention may be implemented in the form of program instructions executable through various computer means and recorded in a computer-readable medium. The computer-readable medium may include program instructions, data files, data structures, etc., alone or in combination. The program instructions recorded in the computer-readable medium may be specially designed and formed for the example embodiments of the present invention, or may be known to and used by those skilled in the art of the computer software field.

The computer-readable medium may be a hardware device specially configured to store and execute program instructions, such as a read only memory (ROM), a random access memory (RAM), or a flash memory. The hardware device may be configured to operate as at least one software module to perform the operation according to example embodiments of the present invention, and vice versa. The program instruction may be mechanical codes as made by a compiler, as well as high-level language codes executable by a computer based on an interpreter or the like.

While the example embodiments of the present invention and their advantages have been described in detail, it should be understood that various changes, substitutions and alterations may be made herein without departing from the scope of the invention.

What is claimed is:

1. A method for communication, performed in a first station, the method comprising:
receiving a capability notification frame including first capability-related information from a second station; and
configuring a power saving mode of the first station based on the first capability-related information.

2. The method of claim 1, wherein the first capability-related information include at least one of capability information of the second station and an indicator indicating notification of the capability information of the second station.

3. The method of claim 2, wherein the capability information of the second station include at least one of information on a wireless local area network (WLAN) standard version, operation bandwidths, a center frequency, and operation bands supported by the second station.

4. The method of claim 2, wherein the power saving mode of the first station is configured based on the capability information of the second station, when the first capability-related information include the capability information of the second station.

5. The method of claim 1, further comprising:
transmitting a capability request frame including second capability-related information to the second station, wherein the capability notification frame is a response to the capability request frame.

6. The method of claim 5, wherein the second capability-related information include at least one of capability information of the first station and an indicator indicating notification of the capability information of the first station.

7. The method of claim 6, wherein the capability information of the first station include at least one of information on a WLAN standard version, operation bandwidths, a center frequency, and operation bands supported by the first station.

8. The method of claim 6, wherein the power saving mode of the second station is configured based on the capability information of the first station, when the second capability-related information include the capability information of the first station.

9. The method of claim 6, wherein the power saving of the second station is configured based on capability of the second station, when the second capability-related information include the indicator indicating notification of the capability information of the first station.

10. The method of claim 6, wherein the power saving mode of the second station is configured based on the capability information of the first station and the capability of the second station, when the second capability-related information include the capability information of the first station.

11. The method of claim 1, wherein the capability notification frame is a clear-to-send (CTS) frame or a data frame.

12. The method of claim 1, wherein the capability request frame is a request-to-send (RTS) frame or a power save (PS)-poll frame.

13. A method for communication, performed in a station, the method comprising:
when a data frame is received from an access point in an Orthogonal Frequency Division Multiple Access (OFDMA) manner, obtaining length information of an actual data field excluding a padding part in the received data frame; and
operating in a power saving mode based on the length information of the actual data field from a reception end point of the actual data field.

14. The method of claim 13, wherein the length information of the actual data field is included in a signal A (SIGA) field or a signal B (SIGB) field of the data frame.

15. The method of claim 13, further comprising:
operating in an awake mode from the reception end point of the data frame.

16. A communication station comprising:
a reception unit, including a plurality of units, configured to receive a frame; and
a power management unit configured to control a power provided to each of the plurality of units according to each reception state of the frame.

17. The station of claim 16, wherein, in a carrier sensing state, the power management unit configured to activate a carrier sensing unit among the plurality of units through control of a power provided to the carrier-sensing unit.

18. The station of claim 16, wherein, when a short training field (STF) of the frame is received in the reception unit, the power management unit configured to activate a unit performing operations based on the STF among the plurality of units through control of a power provided to the unit performing operations based on the STF.

19. The station of claim 16, wherein, when a long training field (LTF) of the frame is received in the reception unit, the power management unit configured to activate a unit performing operations based on the LTF among the plurality of units through control of a power provided to the unit performing operations based on the LTF.

20. The station of claim 16, wherein, when a signal (SIG) field of the frame is received in the reception unit, the power management unit configured to activate a unit performing operations based on the SIG field among the plurality of units through control of a power provided to the unit performing operations based on the SIG field.

21. The station of claim 16, wherein, when a data field of the frame is received in the reception unit, the power management unit configured to activate a unit performing operations based on the data field among the plurality of units through control of a power provided to the unit performing operations based on the data field.
